(19) United States
(12) Patent Application Publication
(10) Pub. No.: US 2024/0276524 A1
(43) Pub. Date: Aug. 15, 2024

(54) RESERVED RESOURCES FOR SIDELINK CONTROL INFORMATION

(71) Applicant: QUALCOMM Incorporated, San Diego, CA (US)

(72) Inventors: Chih-Hao LIU, San Diego, CA (US); Jing SUN, San Diego, CA (US); Junyi LI, Greentown, PA (US); Xiaoxia ZHANG, San Diego, CA (US); Yisheng XUE, San Diego, CA (US); Luanxia YANG, Beijing (CN)

(21) Appl. No.: 18/569,670

(22) PCT Filed: Aug. 31, 2021
(86) PCT No.: PCT/CN2021/115520

§ 371 Date: Dec. 13, 2023

(51) Int. Cl. H04W 72/25; H04W 72/0446; H04W 72/40

(52) U.S. Cl. CPC H04W 72/25; H04W 72/0446; H04W 72/40

(57) ABSTRACT

Wireless communications systems and methods related to communicating control information are provided. A method of wireless communication performed by a first user equipment (UE) may include transmitting, to a second UE, first stage sidelink control information (SCI-1) using a first set of resources of a resource pool (RP), wherein the RP indicates resources reserved for communicating the SCI-1 and transmitting, to the second UE, the SCI-1 using a second set of resources of the RP, wherein the second set of resources is different from the first set of resources

### TECHNICAL FIELD

This application relates to wireless communication systems, and more particularly to methods and devices for reserving resources for sidelink control information.

### INTRODUCTION

Wireless communications systems are widely deployed to provide various types of communication content such as voice, video, packet data, messaging, broadcast, and so on. These systems may be capable of supporting communication with multiple users by sharing the available system resources (e.g., time, frequency, and power). A wireless multiple-access communications system may include a number of base stations (BSs), each simultaneously supporting communications for multiple communication devices, which may be otherwise known as user equipment (UE).

To meet the growing demands for expanded mobile broadband connectivity, wireless communication technologies are advancing from the LTE technology to a next generation new radio (NR) technology. For example, NR is designed to provide a lower latency, a higher bandwidth or throughput, and a higher reliability than LTE. NR is designed to operate over a wide array of spectrum bands, for example, from low-frequency bands below about 1 gigahertz (GHz) and mid-frequency bands from about 1 GHz to about 6 GHz, to high-frequency bands such as millimeter wave (mm Wave) bands. NR is also designed to operate across different spectrum types, from licensed spectrum to unlicensed and shared spectrum. Spectrum sharing enables operators to opportunistically aggregate spectrums to dynamically support high-bandwidth services. Spectrum sharing can extend the benefit of NR technologies to operating entities that may not have access to a licensed spectrum.

NR may support various deployment scenarios to benefit from the various spectrums in different frequency ranges, licensed and/or unlicensed, and/or coexistence of the LTE and NR technologies. For example, NR can be deployed in a standalone NR mode over a licensed and/or an unlicensed band or in a dual connectivity mode with various combinations of NR and LTE over licensed and/or unlicensed bands.

In a wireless communication network, a BS may communicate with a UE in an uplink direction and a downlink direction. Sidelink was introduced in LTE to allow a UE to send data to another UE (e.g., from one vehicle to another vehicle) without tunneling through the BS and/or an associated core network. The LTE sidelink technology has been extended to provision for device-to-device (D2D) communications, vehicle-to-everything (V2X) communications, and/or cellular vehicle-to-everything (C-V2X) communications. Similarly, NR may be extended to support sidelink communications, D2D communications, V2X communications, and/or C-V2X over licensed bands and/or unlicensed bands.

### BRIEF SUMMARY OF SOME EXAMPLES

The following summarizes some aspects of the present disclosure to provide a basic understanding of the discussed technology. This summary is not an extensive overview of all contemplated features of the disclosure and is intended neither to identify key or critical elements of all aspects of the disclosure nor to delineate the scope of any or all aspects of the disclosure. Its sole purpose is to present some concepts of one or more aspects of the disclosure in summary form as a prelude to the more detailed description that is presented later.

For example, in an aspect of the disclosure, a method of wireless communication performed by a user equipment (UE) may include transmitting, to a second UE, first stage sidelink control information (SCI-1) using a first set of resources of a resource pool (RP), wherein the RP indicates resources reserved for communicating the SCI-1 and transmitting, to the second UE, the SCI-1 using a second set of resources of the RP, wherein the second set of resources is different from the first set of resources.

In an additional aspect of the disclosure, a method of communication performed by a UE may include receiving, from a second UE, first stage sidelink control information (SCI-1) using a first set of resources of a resource pool (RP), wherein the RP indicates resources reserved for communicating the SCI-1 and receiving, from the second UE, the SCI-1 using a second set of resources of the RP, wherein the second set of resources is different from the first set of resources.

In an additional aspect of the disclosure, a first UE may include a transceiver, a memory, and a processor coupled to the transceiver and the memory, the first UE may be configured to transmit, to a second UE, first stage sidelink control information (SCI-1) using a first set of resources of a resource pool (RP), wherein the RP indicates resources reserved for communicating the SCI-1 and transmit, to the second UE, the SCI-1 using a second set of resources of the RP, wherein the second set of resources is different from the first set of resources.

In an additional aspect of the disclosure, a first UE may include a transceiver, a memory, and a processor coupled to the transceiver and the memory, the first UE may be configured to receive, from a second UE, first stage sidelink control information (SCI-1) using a first set of resources of a resource pool (RP), wherein the RP indicates resources reserved for communicating the SCI-1 and receive, from the second UE, the SCI-1 using a second set of resources of the RP, wherein the second set of resources is different from the first set of resources.

Other aspects, features, and instances of the present invention will become apparent to those of ordinary skill in the art, upon reviewing the following description of specific, exemplary instances of the present invention in conjunction with the accompanying figures. While features of the present invention may be discussed relative to certain aspects and figures below, all instances of the present invention can include one or more of the advantageous features discussed herein. In other words, while one or more instances may be discussed as having certain advantageous features, one or more of such features may also be used in accordance with the various instances of the invention discussed herein. In similar fashion, while exemplary aspects may be discussed below as device, system, or method instances it should be understood that such exemplary instances can be implemented in various devices, systems, and methods.

### BRIEF DESCRIPTION OF THE DRAWINGS

FIG. 1 illustrates a wireless communication network according to some aspects of the present disclosure.

FIG. 2 illustrates sidelink resources associated with a wireless communication network according to some aspects of the present disclosure.

FIG. 3 illustrates resources reserved for repeated transmission of sidelink control information according to some aspects of the present disclosure.

FIG. 4 illustrates resources reserved for repeated transmission of sidelink control information according to some aspects of the present disclosure.

FIG. 5 is a signaling diagram of a communication method according to some aspects of the present disclosure.

FIG. 6 is a block diagram of an exemplary user equipment (UE) according to some aspects of the present disclosure.

FIG. 7 is a block diagram of an exemplary base station (BS) according to some aspects of the present disclosure.

FIG. 8 is a flow diagram of a communication method according to some aspects of the present disclosure.

FIG. 9 is a flow diagram of a communication method according to some aspects of the present disclosure.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

This disclosure relates generally to wireless communications systems, also referred to as wireless communications networks. In various instances, the techniques and apparatus may be used for wireless communication networks such as code division multiple access (CDMA) networks, time division multiple access (TDMA) networks, frequency division multiple access (FDMA) networks, orthogonal FDMA (OFDMA) networks, single-carrier FDMA (SC-FDMA) networks, LTE networks, GSM networks, 5th Generation (5G) or new radio (NR) networks, as well as other communications networks. As described herein, the terms “networks” and “systems” may be used interchangeably.

An OFDMA network may implement a radio technology such as evolved UTRA (E-UTRA), Institute of Electrical and Electronic Engineers (IEEE) 802.11, IEEE 802.16, IEEE 802.20, flash-OFDM and the like. UTRA, E-UTRA, and Global System for Mobile Communications (GSM) are part of universal mobile telecommunication system (UMTS). In particular, long term evolution (LTE) is a release of UMTS that uses E-UTRA. UTRA, E-UTRA, GSM, UMTS and LTE are described in documents provided from an organization named “3rd Generation Partnership Project” (3GPP), and cdma2000 is described in documents from an organization named “3rd Generation Partnership Project 2” (3GPP2). These various radio technologies and standards are known or are being developed. For example, the 3rd Generation Partnership Project (3 GPP) is a collaboration between groups of telecommunications associations that aims to define a globally applicable third generation (3G) mobile phone specification. 3GPP long term evolution (LTE) is a 3GPP project which was aimed at improving the universal mobile telecommunications system (UMTS) mobile phone standard. The 3GPP may define specifications for the next generation of mobile networks, mobile systems, and mobile devices. The present disclosure is concerned with the evolution of wireless technologies from LTE, 4G, 5G, NR, and beyond with shared access to wireless spectrum between networks using a collection of new and different radio access technologies or radio air interfaces.

In particular, 5G networks contemplate diverse deployments, diverse spectrum, and diverse services and devices that may be implemented using an OFDM-based unified, air interface. In order to achieve these goals, further enhancements to LTE and LTE-A are considered in addition to development of the new radio technology for 5G NR networks. The 5G NR will be capable of scaling to provide coverage (1) to a massive Internet of things (IoTs) with an ultra-high density (e.g., ˜1M nodes/km²), ultra-low complexity (e.g., ˜10s of bits/sec), ultra-low energy (e.g., ˜10+ years of battery life), and deep coverage with the capability to reach challenging locations; (2) including mission-critical control with strong security to safeguard sensitive personal, financial, or classified information, ultra-high reliability (e.g., ˜99.9999% reliability), ultra-low latency (e.g., ˜ 1 ms), and users with wide ranges of mobility or lack thereof; and (3) with enhanced mobile broadband including extreme high capacity (e.g., ˜10 Tbps/km²), extreme data rates (e.g., multi-Gbps rate, 100+ Mbps user experienced rates), and deep awareness with advanced discovery and optimizations.

The 5G NR may be implemented to use optimized OFDM-based waveforms with scalable numerology and transmission time interval (TTI); having a common, flexible framework to efficiently multiplex services and features with a dynamic, low-latency time division duplex (TDD)/frequency division duplex (FDD) design; and with advanced wireless technologies, such as massive multiple input, multiple output (MIMO), robust millimeter wave (mm Wave) transmissions, advanced channel coding, and device-centric mobility. Scalability of the numerology in 5G NR, with scaling of subcarrier spacing, may efficiently address operating diverse services across diverse spectrum and diverse deployments. For example, in various outdoor and macro coverage deployments of less than 3 GHz FDD/TDD implementations, subcarrier spacing may occur with 15 kHz, for example over 5, 10, 20 MHZ, and the like bandwidth (BW). For other various outdoor and small cell coverage deployments of TDD greater than 3 GHz, subcarrier spacing may occur with 30 kHz over 80/100 MHz BW. For other various indoor wideband implementations, using a TDD over the unlicensed portion of the 5 GHz band, the subcarrier spacing may occur with 60 kHz over a 160 MHz BW. Finally, for various deployments transmitting with mmWave components at a TDD of 28 GHz, subcarrier spacing may occur with 120 kHz over a 500 MHz BW.

The scalable numerology of the 5G NR facilitates scalable TTI for diverse latency and quality of service (QOS) requirements. For example, shorter TTI may be used for low latency and high reliability, while longer TTI may be used for higher spectral efficiency. The efficient multiplexing of long and short TTIs to allow transmissions to start on symbol boundaries. 5G NR also contemplates a self-contained integrated subframe design with uplink/downlink scheduling information, data, and acknowledgement in the same subframe. The self-contained integrated subframe supports communications in unlicensed or contention-based shared spectrum, adaptive uplink/downlink that may be flexibly configured on a per-cell basis to dynamically switch between uplink and downlink to meet the current traffic needs.

Various other aspects and features of the disclosure are further described below. It should be apparent that the teachings herein may be embodied in a wide variety of forms and that any specific structure, function, or both being disclosed herein is merely representative and not limiting. Based on the teachings herein one of an ordinary level of skill in the art should appreciate that an aspect disclosed herein may be implemented independently of any other aspects and that two or more of these aspects may be combined in various ways. For example, an apparatus may be implemented or a method may be practiced using any number of the aspects set forth herein. In addition, such an apparatus may be implemented or such a method may be practiced using other structure, functionality, or structure and functionality in addition to or other than one or more of the aspects set forth herein. For example, a method may be implemented as part of a system, device, apparatus, and/or as instructions stored on a computer readable medium for execution on a processor or computer. Furthermore, an aspect may comprise at least one element of a claim.

The present application describes mechanisms for repeating the transmission of first stage sidelink control information (SCI-1). The present application further describes mechanisms for reserving time/frequency resources for the repeated transmission of the SCI-1. The reserved resources may be indicated in a resource pool (RP). The RP may indicate time/frequency resources dedicated to repeating the transmission of the SCI-1 in a physical sidelink control channel (PSCCH). The transmission of the SCI-1 using the dedicated resources may be a repeat transmission of the SCI-1. For example, the UE may initially transmit a communication that includes the SCI-1, an SCI-2, and a delay sensitive transport block (TB). The SCI-1 may indicate resources reserved for potential retransmission of the delay sensitive TB in order to increase the probability that the delay sensitive TB will be received within a packet delay budget. The other UE may not receive and/or properly decode the communication that includes the SCI-1, the SCI-2, and the TB resulting in the other UE not respecting the resource reservation for the potential retransmission of the TB. The delay sensitive TB may be transmitted by an industrial Internet of things (IoTs) and/or a vehicle-to-everything (V2X) device. The IoT or V2X devices may communicate data that is time delay sensitive and/or requires high reliability. For example, a UE such as sensor of a robot may need to transmit sensor data to a controller in real time. As another example, a vehicle may need to transmit safety related data to another vehicle in real time. The time delay sensitive TBs may have a packet delay budget in which the TB needs to be received based on the context or application. In some aspects, there may be a requirement for a reliable transmission of the delay sensitive TB. Aspects of the present disclosure may provide methods of increasing the probability that the other UE receives the SCI-1. For example, the UE may repeat the transmission of the SCI-1 multiple times further increasing the probability that the other UE will receive, decode, and respect the resource reservations in the SCI-1 thus increasing the reliability of the TB transmission.

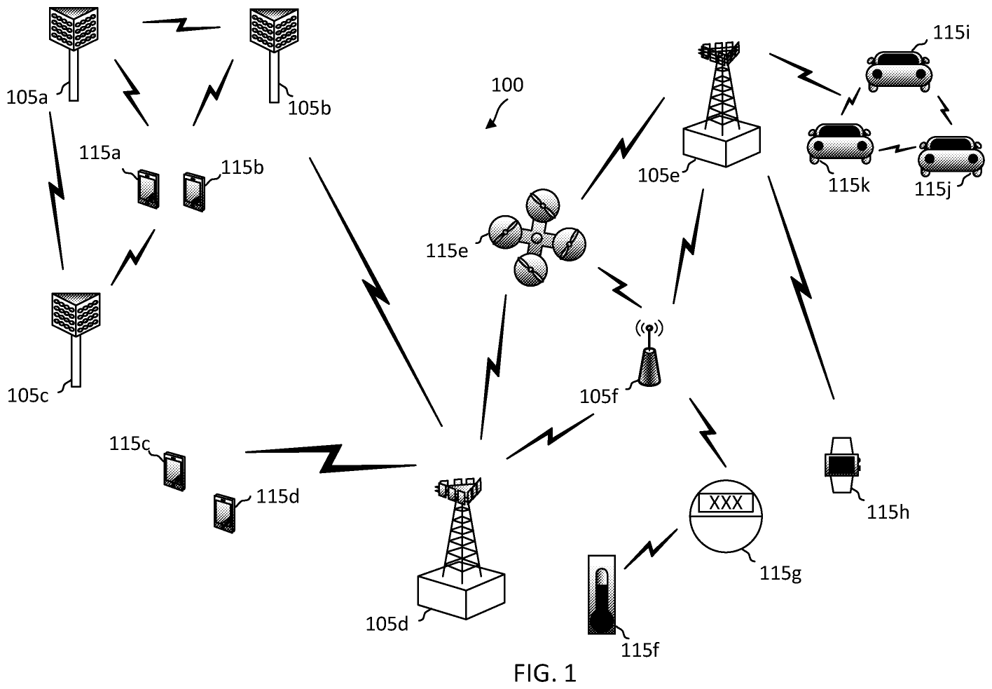

FIG. 1 illustrates a wireless communication network 100 according to some aspects of the present disclosure. The network 100 includes a number of base stations (BSs) 105 and other network entities. A BS 105 may be a station that communicates with UEs 115 and may also be referred to as an evolved node B (eNB), a next generation eNB (gNB), an access point, and the like. Each BS 105 may provide communication coverage for a particular geographic area. In 3GPP, the term “cell” can refer to this particular geographic coverage area of a BS 105 and/or a BS subsystem serving the coverage area, depending on the context in which the term is used.

A BS 105 may provide communication coverage for a macro cell or a small cell, such as a pico cell or a femto cell, and/or other types of cell. A macro cell generally covers a relatively large geographic area (e.g., several kilometers in radius) and may allow unrestricted access by UEs with service subscriptions with the network provider. A small cell, such as a pico cell, would generally cover a relatively smaller geographic area and may allow unrestricted access by UEs with service subscriptions with the network provider. A small cell, such as a femto cell, would also generally cover a relatively small geographic area (e.g., a home) and, in addition to unrestricted access, may also provide restricted access by UEs having an association with the femto cell (e.g., UEs in a closed subscriber group (CSG), UEs for users in the home, and the like). A BS for a macro cell may be referred to as a macro BS. A BS for a small cell may be referred to as a small cell BS, a pico BS, a femto BS or a home BS. In the example shown in FIG. 1, the BSs 105d and 105e may be regular macro BSs, while the BSs 105a-105c may be macro BSs enabled with one of three dimension (3D), full dimension (FD), or massive MIMO. The BSs 105a-105c may take advantage of their higher dimension MIMO capabilities to exploit 3D beamforming in both elevation and azimuth beamforming to increase coverage and capacity. The BS 105f may be a small cell BS which may be a home node or portable access point. A BS 105 may support one or multiple (e.g., two, three, four, and the like) cells.

The network 100 may support synchronous or asynchronous operation. For synchronous operation, the BSs may have similar frame timing, and transmissions from different BSs may be approximately aligned in time. For asynchronous operation, the BSs may have different frame timing, and transmissions from different BSs may not be aligned in time.

The UEs 115 are dispersed throughout the wireless network 100, and each UE 115 may be stationary or mobile. A UE 115 may also be referred to as a terminal, a mobile station, a subscriber unit, a station, or the like. A UE 115 may be a cellular phone, a personal digital assistant (PDA), a wireless modem, a wireless communication device, a handheld device, a tablet computer, a laptop computer, a cordless phone, a wireless local loop (WLL) station, or the like. In one aspect, a UE 115 may be a device that includes a Universal Integrated Circuit Card (UICC). In another aspect, a UE may be a device that does not include a UICC. In some aspects, the UEs 115 that do not include UICCs may also be referred to as IoT devices or internet of everything (IoE) devices. The UEs 115a-115d are examples of mobile smart phone-type devices accessing network 100. A UE 115 may also be a machine specifically configured for connected communication, including machine type communication (MTC), enhanced MTC (eMTC), narrowband IoT (NB-IoT) and the like. The UEs 115e-115h are examples of various machines configured for communication that access the network 100. The UEs 115i-115k are examples of vehicles equipped with wireless communication devices configured for communication that access the network 100. A UE 115 may be able to communicate with any type of the BSs, whether macro BS, small cell, or the like. In FIG. 1, a lightning bolt (e.g., communication links) indicates wireless transmissions between a UE 115 and a serving BS 105, which is a BS designated to serve the UE 115 on the downlink (DL) and/or uplink (UL), desired transmission between BSs 105, backhaul transmissions between BSs, or sidelink transmissions between UEs 115.

In operation, the BSs 105a-105c may serve the UEs 115a and 115b using 3D beamforming and coordinated spatial techniques, such as coordinated multipoint (CoMP) or multi-connectivity. The macro BS 105d may perform backhaul communications with the BSs 105a-105c, as well as small cell, the BS 105f. The macro BS 105d may also transmits multicast services which are subscribed to and received by the UEs 115c and 115d. Such multicast services may include mobile television or stream video, or may include other services for providing community information, such as weather emergencies or alerts, such as Amber alerts or gray alerts.

The BSs 105 may also communicate with a core network. The core network may provide user authentication, access authorization, tracking, Internet Protocol (IP) connectivity, and other access, routing, or mobility functions. At least some of the BSs 105 (e.g., which may be an example of an evolved NodeB (eNB) or an access node controller (ANC)) may interface with the core network 130 through backhaul links (e.g, S1, S2, etc.) and may perform radio configuration and scheduling for communication with the UEs 115. In various examples, the BSs 105 may communicate, either directly or indirectly (e.g., through core network), with each other over backhaul links (e.g., X1, X2, etc.), which may be wired or wireless communication links.

The network 100 may also support mission critical communications with ultra-reliable and redundant links for mission critical devices, such as the UE 115e, which may be a vehicle (e.g., a car, a truck, a bus, an autonomous vehicle, an aircraft, a boat, etc.). Redundant communication links with the UE 115e may include links from the macro BSs 105d and 105e, as well as links from the small cell BS 105f. Other machine type devices, such as the UE 115f (e.g., a thermometer), the UE 115g (e.g., smart meter), and UE 115h (e.g., wearable device) may communicate through the network 100 either directly with BSs, such as the small cell BS 105f, and the macro BS 105e, or in multi-hop configurations by communicating with another user device which relays its information to the network, such as the UE 115f communicating temperature measurement information to the smart meter, the UE 115g, which is then reported to the network through the small cell BS 105f. The network 100 may also provide additional network efficiency through dynamic, low-latency TDD/FDD communications, such as vehicle-to-vehicle (V2V), vehicle-to-everything (V2X), cellular-vehicle-to-everything (C-V2X) communications between a UE 115i, 115j, or 115k and other UEs 115, and/or vehicle-to-infrastructure (V21) communications between a UE 115i, 115j, or 115k and a BS 105.

In some implementations, the network 100 utilizes OFDM-based waveforms for communications. An OFDM-based system may partition the system BW into multiple (K) orthogonal subcarriers, which are also commonly referred to as subcarriers, tones, bins, or the like. Each subcarrier may be modulated with data. In some instances, the subcarrier spacing between adjacent subcarriers may be fixed, and the total number of subcarriers (K) may be dependent on the system BW. The system BW may also be partitioned into subbands. In other instances, the subcarrier spacing and/or the duration of TTIs may be scalable.

In some instances, the BSs 105 can assign or schedule transmission resources (e.g., in the form of time-frequency resource blocks (RB)) for downlink (DL) and uplink (UL) transmissions in the network 100. DL refers to the transmission direction from a BS 105 to a UE 115, whereas UL refers to the transmission direction from a UE 115 to a BS 105. The communication can be in the form of radio frames. A radio frame may be divided into a plurality of subframes, for example, about 10. Each subframe can be divided into slots, for example, about 2. Each slot may be further divided into mini-slots. In a FDD mode, simultaneous UL and DL transmissions may occur in different frequency bands. For example, each subframe includes a UL subframe in a UL frequency band and a DL subframe in a DL frequency band. In a TDD mode, UL and DL transmissions occur at different time periods using the same frequency band. For example, a subset of the subframes (e.g., DL subframes) in a radio frame may be used for DL transmissions and another subset of the subframes (e.g., UL subframes) in the radio frame may be used for UL transmissions.

The DL subframes and the UL subframes can be further divided into several regions. For example, each DL or UL subframe may have pre-defined regions for transmissions of reference signals, control information, and data. Reference signals are predetermined signals that facilitate the communications between the BSs 105 and the UEs 115. For example, a reference signal can have a particular pilot pattern or structure, where pilot tones may span across an operational BW or frequency band, each positioned at a pre-defined time and a pre-defined frequency. For example, a BS 105 may transmit cell specific reference signals (CRSs) and/or channel state information—reference signals (CSI-RSs) to enable a UE 115 to estimate a DL channel. Similarly, a UE 115 may transmit sounding reference signals (SRSs) to enable a BS 105 to estimate a UL channel. Control information may include resource assignments and protocol controls. Data may include protocol data and/or operational data. In some instances, the BSs 105 and the UEs 115 may communicate using self-contained subframes. A self-contained subframe may include a portion for DL communication and a portion for UL communication. A self-contained subframe can be DL-centric or UL-centric. A DL-centric subframe may include a longer duration for DL communication than for UL communication. A UL-centric subframe may include a longer duration for UL communication than for UL communication.

In some instances, the network 100 may be an NR network deployed over a licensed spectrum. The BSs 105 can transmit synchronization signals (e.g., including a primary synchronization signal (PSS) and a secondary synchronization signal (SSS)) in the network 100 to facilitate synchronization. The BSs 105 can broadcast system information associated with the network 100 (e.g., including a master information block (MIB), remaining minimum system information (RMSI), and other system information (OSI)) to facilitate initial network access. In some instances, the BSs 105 may broadcast the PSS, the SSS, and/or the MIB in the form of synchronization signal blocks (SSBs) over a physical broadcast channel (PBCH) and may broadcast the RMSI and/or the OSI over a physical downlink shared channel (PDSCH).

In some instances, a UE 115 attempting to access the network 100 may perform an initial cell search by detecting a PSS from a BS 105. The PSS may enable synchronization of period timing and may indicate a physical layer identity value. The UE 115 may then receive a SSS. The SSS may enable radio frame synchronization, and may provide a cell identity value, which may be combined with the physical layer identity value to identify the cell. The SSS may also enable detection of a duplexing mode and a cyclic prefix length. The PSS and the SSS may be located in a central portion of a carrier or any suitable frequencies within the carrier.

After receiving the PSS and SSS, the UE 115 may receive a MIB. The MIB may include system information for initial network access and scheduling information for RMSI and/or OSI. After decoding the MIB, the UE 115 may receive RMSI and/or OSI. The RMSI and/or OSI may include radio resource control (RRC) information related to random access channel (RACH) procedures, paging, control resource set (CORESET) for physical downlink control channel (PDCCH) monitoring, physical uplink control channel (PUCCH), physical uplink shared channel (PUSCH), power control, SRS, and cell barring.

After obtaining the MIB, the RMSI and/or the OSI, the UE 115 can perform a random access procedure to establish a connection with the BS 105. For the random access procedure, the UE 115 may transmit a random access preamble and the BS 105 may respond with a random access response. Upon receiving the random access response, the UE 115 may transmit a connection request to the BS 105 and the BS 105 may respond with a connection response (e.g., contention resolution message).

After establishing a connection, the UE 115 and the BS 105 can enter a normal operation stage, where operational data may be exchanged. For example, the BS 105 may schedule the UE 115 for UL and/or DL communications. The BS 105 may transmit UL and/or DL scheduling grants to the UE 115 via a PDCCH. The BS 105 may transmit a DL communication signal to the UE 115 via a PDSCH according to a DL scheduling grant. The UE 115 may transmit a UL communication signal to the BS 105 via a PUSCH and/or PUCCH according to a UL scheduling grant.

In some aspects, the UE 115g (e.g., a meter, a sensor, a programmable logic controller, an IoT device, a robot, a vehicle, etc.) may transmit an SCI-1 and a delay sensitive TB. The UE 115g may repeat the transmission of the SCI-1 one or more times using reserved resources. The reserved resources may be indicated in a resource pool (RP). The RP may indicate time/frequency resources dedicated to repeating the transmission of the SCI-1 in a physical sidelink control channel (PSCCH). The UE 115f may receive an RP configuration that indicates the time/frequency resources for the repeated SCI-1 transmission. The UE 115g may initially transmit a communication that includes the SCI-1, an SCI-2, and the delay sensitive TB. The SCI-1 may indicate resources reserved for potential retransmission of the delay sensitive TB in order to increase the probability that the delay sensitive TB will be received within a packet delay budget. The UE 115f may be a half-duplex UE and may not receive and/or properly decode the initial transmission of the SCI-1 resulting in the UE 115f not respecting the resource reservation for the potential retransmission of the delay sensitive TB. The UE 115g may repeat the transmission of the SCI-1 in the reserved resources one or more time to increase the probability that the UE 115f correctly receives and decodes the SCI-1 and respects the resources reserved for future transmissions or retransmissions of the delay sensitive TB.

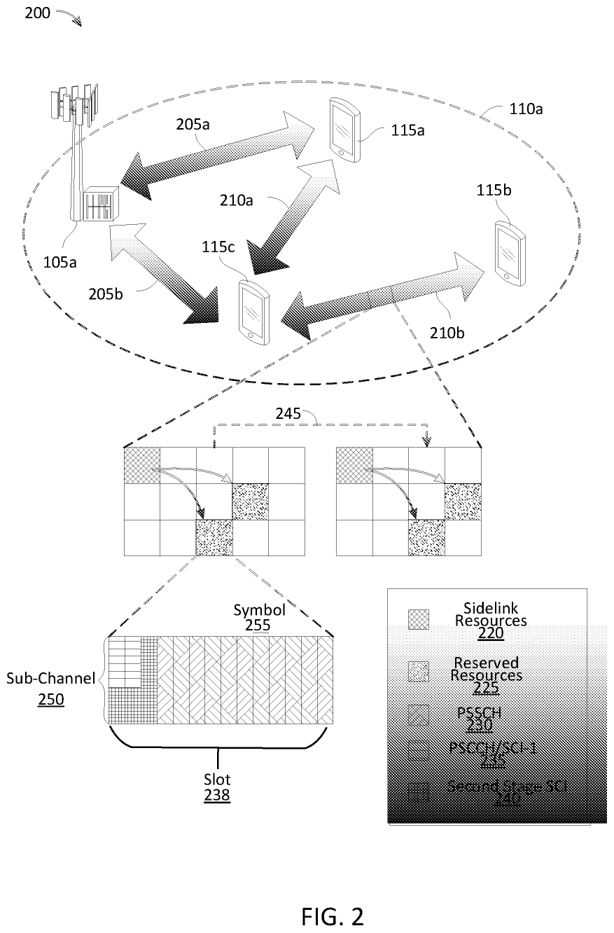

FIG. 2 illustrates sidelink resources associated with a wireless communication network 200 according to some aspects of the present disclosure. The wireless communications network 200 may include a base station 105a and UEs 115a, 115b, and 115c, which may be examples of a BS 105 and a UE 115 as described with reference to FIG. 1. Base station 105a and UEs 115a and 115c may communicate within geographic coverage area 110a and via communication links 205a and 205b, respectively. UE 115c may communicate with UEs 115a and 115b via sidelink communication links 210a and 210b, respectively. In some examples, UE 115c may transmit SCI to UEs 115a and 115b via the sidelink control resources 220. The SCI may include an indication of resources reserved for retransmissions by UE 115c (e.g., the reserved resources 225). In some examples, UEs 115a and 115b may determine to reuse one or more of the reserved resources 225.

In some aspects, a device in the wireless communication network 200 (e.g., a UE 115, a BS 105, or some other node) may convey SCI to another device (e.g., another UE 115, a BS 105, sidelink device or vehicle-to-everything (V2X) device, or other node). The SCI may be conveyed in one or more stages. The first stage SCI-1 may be carried on the PSCCH while the second stage SCI-2 may be carried on the corresponding PSSCH. For example, UE 115c may transmit a PSCCH/first stage SCI 235 (e.g., SCI-1) to each sidelink UE 115 in the network (e.g., UEs 115a and 115b) via the sidelink communication links 210. The PSCCH/first stage SCI-1 235 may indicate resources that are reserved by UE 115c for retransmissions (e.g., the SCI-1 may indicate the reserved resources 225 for retransmissions). Each sidelink UE 115 may decode the first stage SCI-1 to determine where the reserved resources 225 are located (e.g., to refrain from using resources that are reserved for another sidelink transmission and/or to reduce resource collision within the wireless communications network 200). In some aspects, the UE 115c may repeat the transmission of the SCI-1 in reserved resources in order to increase the probability that other sidelink UEs in the network 200 decode the SCI-1 and respect the resources that are reserved by UE 115c for retransmissions.

Sidelink communication may include a mode 1 operation in which the UEs 115 are in a coverage area of BS 105a. In mode 1, the UEs 115 may receive a configured grant from the BS 105a that defines parameters for the UEs 115 to access the channel. Sidelink communication may also include a mode 2 operation in which the UEs 115 operate autonomously from the BS 105a and perform sensing of the channel to gain access to the channel. In some aspects, during mode 2 sidelink operations, the sidelink UEs 115 may perform channel sensing to locate resources reserved by other sidelink transmissions. The first stage SCI-1 may reduce the need for sensing each channel. For example, the first stage SCI-1 may include an explicit indication such that the UEs 115 may refrain from blindly decoding each channel. The first stage SCI-1 may be transmitted via the sidelink control resources 220. The SCI-1 may be retransmitted one or more times in resources reserved for retransmitting the SCI-1 (e.g., an SCI-1 RP). The sidelink control resources 220 may be configured resources (e.g., time resources or frequency resources) transmitted via a PSCCH 235. In some examples, the PSCCH 235 may be configured to occupy a number of physical resource blocks (PRBs) within a selected frequency. The frequency may include a single subchannel 250 (e.g., 10, 12, 15, 20, 25, or some other number of RBs within the subchannel 250). The time duration of the PSCCH 235 may be configured by the BS 105a (e.g., the PSCCH 235 may span 1, 2, 3, or some other number of symbols 255).

The first stage SCI-1 may include one or more fields to indicate a location of the reserved resources 225. For example, the first stage SCI-1 may include, without limitation, one or more fields to convey a frequency domain resource allocation (FDRA), a time domain resource allocation (TDRA), a resource reservation period 245 (e.g., a period for repeating the SCI transmission and the corresponding reserved resources 225), a modulation and coding scheme (MCS) for a second stage SCI-2 240, a beta offset value for the second stage SCI-2 240, a DMRS port (e.g., one bit indicating a number of data layers), a physical sidelink feedback channel (PSFCH) overhead indicator, a priority, one or more additional reserved bits, or a combination thereof. In some examples, the FDRA may be a number of bits in the first stage SCI-1 that may indicate a number of slots and a number of subchannels reserved for the reserved resources 225 (e.g., a receiving UE 115 may determine a location of the reserved resources 225 based on the FDRA by using the subchannel 250 including the PSCCH 235 and first stage SCI-1 as a reference). The TDRA may be a number of bits in the first stage SCI-1 (e.g., 5 bits, 9 bits, or some other number of bits) that may indicate a number of time resources reserved for the reserved resources 225. In this regard, the first stage SCI-1 may indicate the reserved resources 225 to the one or more sidelink UEs 115 in the wireless communication network 200.

The sidelink UEs 115 may attempt to decode the reserved resources 225 indicated by the first stage SCI-1. In some aspects, the reserved resources 225 may be used for retransmission of sidelink data. Additionally or alternatively, the reserved resources 225 may include resources for sidelink transmissions, such as a PSSCH 230. The slot 238 as shown in FIG. 2 is not partitioned into sub-slots. As described below, the slot 238 may be partitioned into multiple sub-slots. The sub-slots may be transmitted via PSSCH 230 using one or more symbols 255. In some examples, the PSSCH 230 may be transmitted via one or more time and/or frequency resources via one or more full or partial symbols 255. A second stage SCI-2 240 may be transmitted via one or more symbols 255 of the PSSCH 230. The second stage SCI-2 240 may be transmitted in a symbol(s) near or at the beginning of a slot. The second stage SCI-2 240 may include an indication of which of the reserved resources 225 the transmitting UE 115 may use for sidelink transmissions. The second stage SCI-2 240 may thereby be received and decoded by sidelink UEs 115 intended to receive and decode the corresponding sidelink communications. In some aspects, the transmitting UE 115 may transmit first-stage SCI-1 to one or more receiving UEs 115 indicating whether the transmission of the SCI-1 will be repeated in reserved resources as described below.

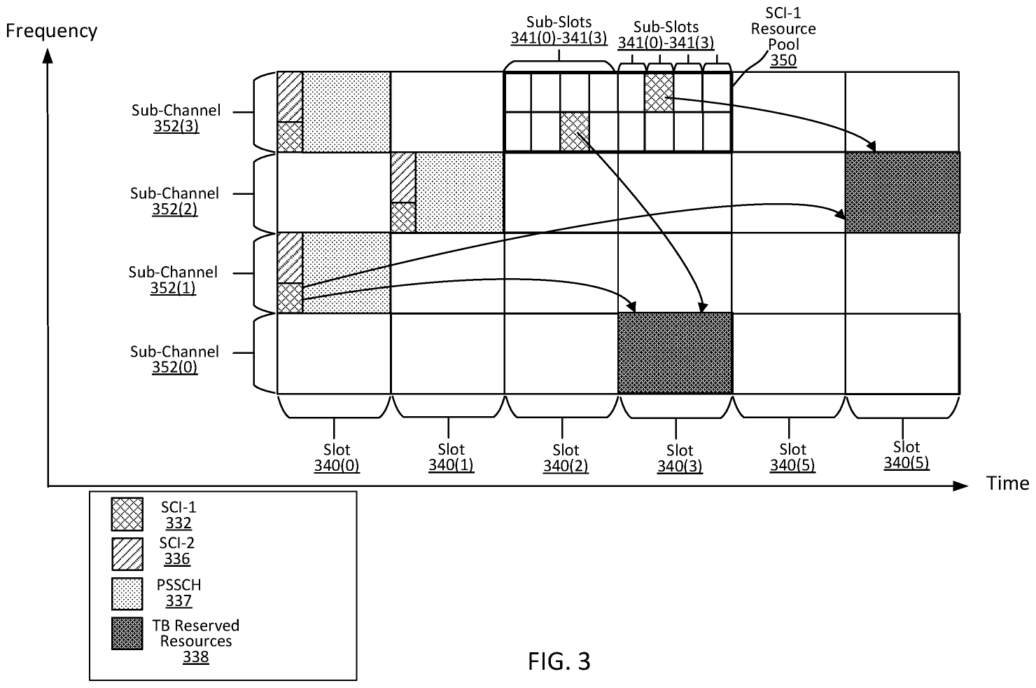

FIG. 3 illustrates reserved resources for repeated transmission of first stage sidelink control information (SCI-1) 332 according to some aspects of the present disclosure. In FIG. 3, the x-axis represents time in some arbitrary units and the Y-axis represents frequency in some arbitrary units. In some aspects, the UE (e.g., the UE 115, the UE 600) may transmit the SCI-1 332 using a first set of resources of a resource pool (RP) 350. In some instances, the RP 350 indicates resources reserved for repeated transmission of the SCI-1 332. The RP 350 may indicate time/frequency resources dedicated to repeating the transmission of the SCI-1 332 in a physical sidelink control channel (PSCCH). For example, the UE may initially transmit a communication that includes the SCI-1 332, an SCI-2 336, and a delay sensitive transport block (TB) carried by the physical sidelink shared channel (PSSCH) 337. The SCI-1 332 may indicate reserved resources 338 for potential retransmission of the delay sensitive TB in order to increase the probability that the delay sensitive TB will be received within a packet delay budget. The other UE (e.g., a half-duplex UE) may not receive and/or properly decode the communication that includes the SCI-1 332, the SCI-2 336, and the TB resulting in the other UE not respecting the reserved resources 338 for the potential retransmission of the TB. As shown in FIG. 3, the two reserved resources 338 for the potential retransmission of the TB are indicated by the arrows pointing to slot 340(3)/sub-channel 352(0) and slot 340(5)/sub-channel 352 (2). Aspects of the present disclosure may provide methods of increasing the probability that the other UE receives the SCI-1 332. For example, the UE may repeat the transmission of the SCI-1 332 using the resources in the RP 350 dedicated to the SCI-1 332. In some aspects, the UE may repeat the transmission of the SCI-1 332 multiple times further increasing the probability that the other UE will receive, decode, and respect the resource reservations in the SCI-1 332 thus increasing the reliability of the TB transmission.

In some aspects, the UE may receive an RP configuration that includes and/or configures the RP 350. The UE may receive the RP configuration from a BS (e.g., the BS 105 or the BS 700). In this regard, the UE may receive the RP configuration from the BS via at least one of radio resource control (RRC) signaling, PDCCH signaling, or media access control (MAC) control element (CE) signaling. The RP configuration may include, without limitation, a location (e.g., time and/or frequency) of the resource elements dedicated to the repeat transmission of the SCI-1. In some aspects, the UE may receive the RP configuration from another UE (e.g., the UE 115 or the UE 600). In this regard, the UE may receive the RP configuration from another UE via at least one of a physical sidelink control channel (PSCCH), an SCI-1, an SCI-2, a physical sidelink shared channel (PSSCH) 337, physical sidelink broadcast channel (PSBCH) communications, physical downlink control channel (PDCCH) communications, physical downlink shared channel (PDSCH) communications, physical broadcast channel (PBCH) communications and/or other types of sidelink communications. In some aspects, the UE may transmit the RP configuration to another UE.

The RP configuration may further indicate one or more sets of resources that can be utilized for transmitting the SCI-1 332. For example, in some instances the RP configuration may indicate sub-slot 341(2) in slot 340(2) for transmitting a first repetition of the SCI-1 332 and sub-slot 341(1) in slot 340(3) for transmitting a second repetition of the SCI-1 332. The UE may transmit the SCI-1 332 in sub-slot 341 (2) in slot 340(2) and transmit (e.g., retransmit) the SCI-1 332 in sub-slot 341(1) in slot 340(3). The resources may include time domain resources that include certain symbols, slots 340, and/or sub-slots 341 reserved for the SCI-1 332. The resources may include frequency domain resources that include a certain frequency, a range of frequencies, sub-channels 352, or subband(s) reserved for the transmission of the SCI-1 332. For example, the RP configuration for the SCI-1 332 may include a mapping of the first set of resources to sub-slot 341 (2) in slot 340(2) and sub-channel 352(3). The RP configuration may further include a mapping of the second set of resources to sub-slot 341(1) in slot 340(3) and sub-channel 352(3). The second set of resource may be different from the first set of resources. In some instances, the second transmission of the SCI-1 332 may follow (e.g., immediately follow) the first transmission of the SCI-1 332 to increase the probability that other UEs will receive the repeated SCI-1s 332. In some aspects, the UE may transmit any number of repeated SCI-1s 332. For examples, the UE may transmit the SCI-1 in a third set of resources, a fourth set of resources, etc. Each repeated transmission of the SCI-1 332 may be repeated within a window of time starting from the transmission of the delay sensitive TB in slot 340(0) to the end of the packet delay budget associated with the delay sensitive TB.

The RP configuration may indicate a location of each set of time domain resources reserved for repeating the SCI-1 332 transmission. For example, the set of time domain resources may include sub-slots 341(0) . . . 341(3). In some aspects, a slot 340 may be partitioned in the time domain into sub-slots 341. Each of the sub-slots 341 may include at least one symbol. In this regard, each sub-slot 341 may include 1, 2, 3, 4, 5 or more symbols. In some instances, the sub-slot 341 may include symbols for an automatic gain control (AGC) signal, a PSCCH to carry the SCI-1 332, and a gap period. For example, the sub-slot 341 may include the AGC signal mapped to the leading symbol, the PSCCH mapped to one or two symbols following the leading symbol, and the gap symbol mapped to the last symbol of the sub-slot 341 and/or any symbol(s) following the PSCCH symbol(s). The RP configuration may also indicate a location of the frequency domain resources reserved for repeating the SCI-1 332 transmission. For example, the RP 350 may indicate a number of frequency sub-channels 352(0) . . . 352(3), subbands, or ranges of frequencies reserved for the PSCCH to carry the repeated SCI-1 332. In some aspects, the RP 350 may indicate the same frequency resources (e.g., the same sub-channels 352, subbands, or ranges of frequencies) reserved for the PSCCH for carrying the repeated SCI-1 332 but different time domain resources. In some aspects, the time domain resources may indicate the same symbols within a slot 340 or sub-slot 341 while indicating a different slot 340 or sub-slot 341. The time domain resources may be consecutive in time to increase the probability of the repeated SCI-1 332 being received by the other UE(s).

In some aspects, the RP 350 for the SCI-1 may be indexed. In this regard, each value of the index may be associated with a set of time resources (e.g., a set of symbols), slots 340(0) . . . 340(5), sub-slots 341(0) . . . 341(3) and/or a set of frequency resources (e.g., a number of frequency sub-channels 352(0) . . . 352(3), subbands, and/or a range of frequencies). The index may be used by the UE to determine and/or locate the resources dedicated to the repeated transmission of the SCI-1 332. The index value may be determined using any suitable method. For example, in some instances the index value may be determined by a hashing function of an index value associated with a slot 340 and/or sub-slot 341 in which the set of resources are located and a resource identifier. The resource identifier may be based on a UE identifier associated with the UE that transmits the delay sensitive TB and/or a UE identifier associated with the UE that monitors for the repeated SCI-1 332. In some aspects, the resource identifier may be based on a link identifier. The link identifier may be based on the UE identifier associated with the UE that transmits the delay sensitive TB and the UE that monitors for the repeated SCI-1 332. In this regard, the link identifier may be a concatenation of a portion of the UE identifier associated with the UE that transmits the delay sensitive TB and a portion of the UE identifier of the UE that monitors for the repeated SCI-1 332.

In some aspects, the UE that transmits the delay sensitive TB may determine a set of candidate resource index values associated with the RP 350 dedicated to the repeated transmission of the SCI-1 332. The UE may determine the set of candidate resource index values based on a hashing function of an index value associated with a slot 340 and/or sub-slot 341 in which the resources are located, the number of candidate resources, the number of sub-slots 341 in the slot 340, and the link identifier. The hashing function may generate a different set of candidate resource index values for each slot 340 and/or sub-slot 341. The UE may select a resource index value from the set of candidate resource index values for other UEs to monitor for the repeated SCI-1s 332.

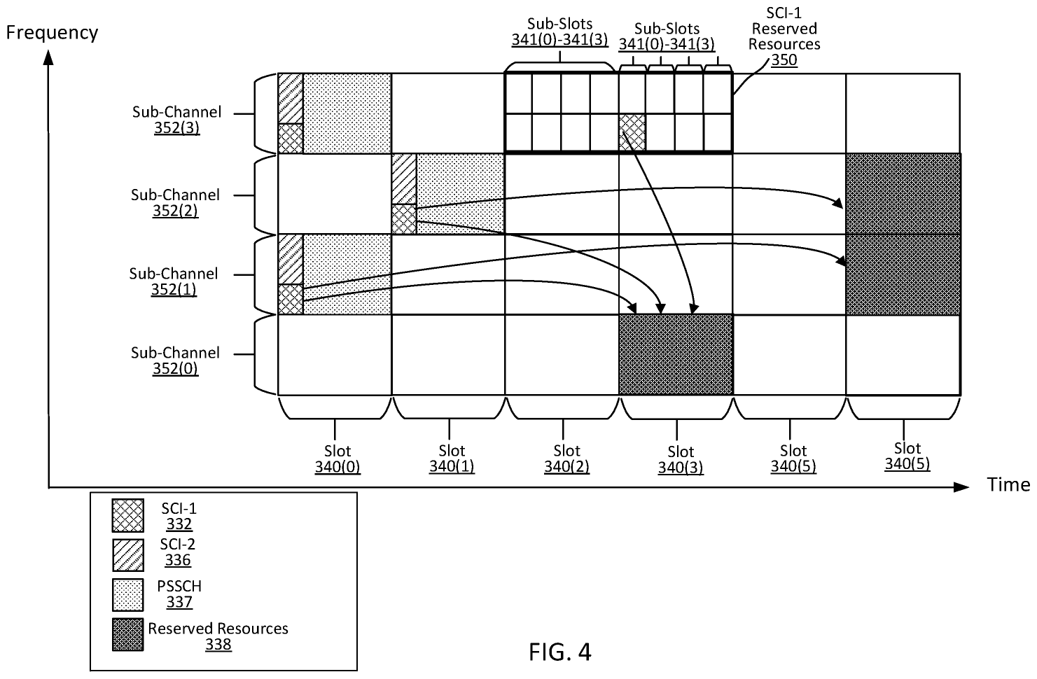

FIG. 4 illustrates reserved resources for repeated transmission of first stage sidelink control information (SCI-1) 332 according to some aspects of the present disclosure. In FIG. 4, the x-axis represents time in some arbitrary units and the Y-axis represents frequency in some arbitrary units. As described above with reference to FIG. 3, a UE (e.g., the UE 115, the UE 600) may transmit the SCI-1 332 using a first set of resources of a resource pool (RP) 350. In some instances, the RP 350 indicates resources reserved for repeated transmission of the SCI-1 332. The RP 350 may indicate time/frequency resources dedicated to repeating the transmission of the SCI-1 332 in a physical sidelink control channel (PSCCH). For example, the UE may initially transmit a communication that includes the SCI-1 332, an SCI-2 336, and a delay sensitive transport block (TB) carried by the physical sidelink shared channel (PSSCH) 337. The SCI-1 332 may indicate resources reserved for potential retransmission of the delay sensitive TB in order to increase the probability that the delay sensitive TB will be received within a packet delay budget.

Additionally or alternatively, the UE may repeat the SCI-1 332 transmission in a subsequent communication in slot 340(1) and sub-channel 352(2) that is not located in the dedicated SCI-1 RP 350. For example, the UE may transmit a first communication in slot 340(0) and sub-channel 352(1) that includes a first SCI-1 332 and a delay sensitive TB. The UE may subsequently transmit a second communication in slot 340(1) and sub-channel 352(2) that includes a second SCI-1 332 and a second TB different from the delay sensitive TB. The first SCI-1 332 in the first communication in slot 340(0) and sub-channel 352(1) may indicate resources reserved for the potential retransmission of the delay sensitive TB. The second SCI-1 332 in the second communication in slot 340(1) and sub-channel 352(2) may indicate the resources reserved for the potential retransmission of the delay sensitive TB and the resources reserved for the potential retransmission of the second TB. However, the second SCI-1 332 in the second communication in slot 340(1) and sub-channel 352(2) may only indicate the resources reserved for the potential retransmission of the delay sensitive TB based on the transmission of the second communication being within the packet delay budget of the delay sensitive TB. In this way, the repeated transmission of the resources reserved for the potential retransmission of the delay sensitive TB in the second SCI-1 332 may increase the probability of other UEs respecting the resources reserved for the potential retransmission of the delay sensitive TB and increase the probability of a successful retransmission of the delay sensitive TB. In some aspects, the second SCI-1 332 transmitted in the second communication in slot 340(1) and sub-channel 352(2) may include an indicator that the second SCI-1 332 includes a repeat transmission of the resource reservation for the delay sensitive TB. In this regard, the indicator may include a combination of one or more bits in a field of the second SCI-1 332 (e.g., a code point in the SCI-1 332). For example, the code point may be included in the time domain resource allocation (TDRA) and/or the frequency domain resource allocation (FDRA).

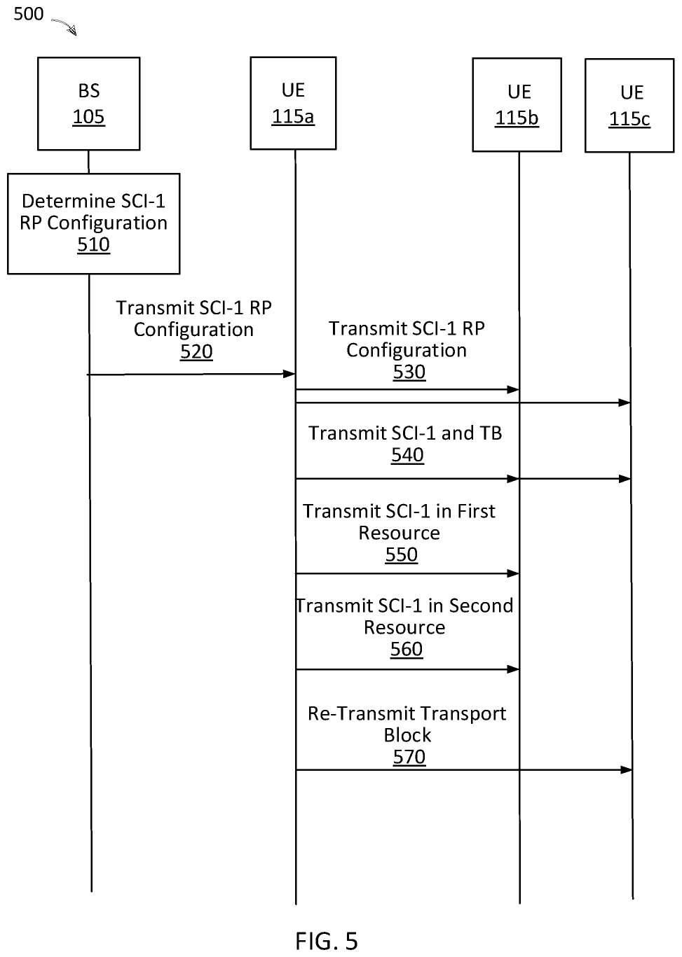

FIG. 5 is a signaling diagram 500 of a communication method according to some aspects of the present disclosure. Aspects of the signaling diagram 500 may be executed by a computing device (e.g., a processor, processing circuit, and/or other suitable component) of a communication device or other suitable means for performing the aspects. For example, a communication device, such as the BS 105 or the BS 700, may utilize one or more components, such as a processor 702, a memory 704, instructions 706, an SCI-1 reservation module 708, a transceiver 710, a modem 712, an RF unit 714, and one or more antennas 716 to execute the steps of signaling diagram 500. A wireless communication device, such as the UE 115 or UE 600, may utilize one or more components, such as the processor 602, the memory 604, the SCI-1 reservation module 608, the transceiver 610, the modem 612, and the one or more antennas 616, to execute signaling diagram 500.

At 510, the BS 105 (or the BS 700) may determine a resource pool configuration for an RP dedicated to the repeat transmission of the SCI-1. The RP may be the RP 350 described above with reference to FIGS. 3 and 4. In some aspects, the RP configuration may be based, at least in part, on network conditions. For example, in some aspects the RP configuration may be based on a distance between the UE 115a and UEs 115b and/or 115c. In some aspects, the UE 115b monitoring the dedicated SCI-1 RP may monitor all resources within the RP. However, monitoring all the resources in the RP may consume an excessive amount of computing resources and/or power. In some aspects, the UE 115b may monitor only the resources within the RP that are associated with UEs that are within a threshold distance to the monitoring UE 115b. For example, the monitoring UE 115b may determine the identifiers associated with the UEs within the threshold distance (e.g., UE 115a) and only monitor the resources associated with those UE identifiers. The threshold distance may be based on signal strength, physical distance, and/or other parameters. The monitoring UE 115b may determine which UEs are within the threshold distance using any suitable method. For example, the monitoring UE 115b may measure a received signal strength from other UEs (e.g., UE 115a and/or 115c) and determine if a received signal strength indicator (RSSI) satisfies a threshold. For example, an RSSI value satisfying the threshold may include an RSSI value greater than −80 dBm, greater than −60 dBm, greater than −40 dBm, or greater than −20 dBm. In some aspects, the UE 115b may receive a communication from the BS 105 indicating the identifiers of the UEs that the UE 115b should be monitoring the dedicated SCI-1 RP for communications from. In some aspects, the monitoring UE 115b may determine identifiers of the UEs within the threshold distance by monitoring the SCI-2 transmissions from the other UEs (e.g., UE 115a and/or 115c). The SCI-2 may include a source identifier that identifies the UE transmitting the SCI-2.

At 520, the BS 105 may transmit the SCI-1 RP configuration to the sidelink UE 115a. In this regard, the BS 105 may transmit the RP configuration to the UE 115a via at least one of radio resource control (RRC) signaling, PDCCH signaling, or media access control (MAC) control element (CE) signaling.

At 530, the UE 115a may transmit the SCI-1 RP configuration to the sidelink UE 115b and/or the sidelink UE 115c. In this regard, the UE115a may transmit the RP configuration to the sidelink UE 115b and/or the sidelink UE 115c via at least one of a physical sidelink control channel (PSCCH), an SCI-1, an SCI-2, a physical sidelink shared channel (PSSCH), physical sidelink broadcast channel (PSBCH) communications, physical downlink control channel (PDCCH) communications, physical downlink shared channel (PDSCH) communications, physical broadcast channel (PBCH) communications and/or other types of sidelink communications.

At 540, the UE 115a may transmit the SCI-1 (e.g., an initial transmission of the SCI-1), an SCI-2, and a delay sensitive TB. The delay sensitive TB may be intended for reception by the UE 115C. The SCI-1 may be intended for reception by both the UE 115b and the UE 115c. The SCI-2 may indicate the source UE (e.g., UE 115a) and the destination UE(s) (e.g., UE 115C). Some UE(s) (e.g., UE 115B) may ignore the TB in response to determining it is not an intended recipient of the TB based on the SCI-2. The UE 115b may be a half-duplex UE and may not receive and/or properly decode the initial transmission of the SCI-1 resulting in the UE 115b not respecting the resource reservation for the potential retransmission of the delay sensitive TB.

At 550, the UE 115a may repeat the transmission of the SCI-1 in a first set of resources configured in the RP dedicated to the repeat transmission of the SCI-1. The SCI-1 may indicate resources reserved for potential retransmission of the delay sensitive TB in order to increase the probability that the delay sensitive TB will be received within a packet delay budget. Since the UE 115b may not receive and decode the SCI-1, the UE 115b may not respect the resource reservation indicated by the SCI-1. Repeating the transmission of the SCI-1 may increase the probability that the UE 115b correctly receives and decodes the SCI-1 and respects the resources reserved for future transmissions or retransmissions.

The delay sensitive TB may have a packet delay budget that indicates a time in which the TB should be received by the UE 115c. If the delay sensitive TB is not correctly received and decoded by the UE 115c, the delay sensitive TB may be retransmitted by the UE 115a in the reserved resources indicated by the SCI-1. Therefore, repeating the transmission of the SCI-1 in a separate and dedicated RP may increase the probability that the resources reserved for the retransmission of the delay sensitive TB will be respected by UE 115b to avoid transmission collisions in the reserved resources. In some aspects, the time between the UE 115b transmitting the initial SCI-1 at 530 and the repeated SCI-1 at 550 may be based on the packet delay budget associated with the TB. For example, the UE 115b may repeat the transmission of the SCI-1 in one or more sub-slots in one or more slots adjacent to the initial transmission at 530 (e.g., a consecutive transmission of the initial SCI-1 and the repeated transmissions of the SCI-1).

In some aspects, the SCI-1 retransmitted at 550 may include an indicator that indicates that physical sidelink shared channel (PSSCH) decoding is not required. The repeated transmission of the SCI-1 at 550 may include a transmission of a PSCCH, an automatic gain control (AGC) symbol, and a gap symbol. The SCI-1 may be carried by the PSCCH. The repeated transmission of the SCI-1 in the reserved resources may include a PSCCH signal to carry the SCI-1 and exclude a PSSCH signal. The SCI-1 may indicate that the SCI-1 is being transmitted in the PSCCH and the UE 115b may refrain from attempting to decode the contents of an associated PSSCH. The UE 115b may reduce power consumption by refraining from attempting to decode the contents of the associated PSSCH. The indicator that indicates PSSCH decoding is not required may include any suitable indicator (e.g., a code point, a flag, a parameter value, etc.). For example, the indicator may include one or more code points that are used for other purposes when the SCI-1 is transmitted in a slot outside of the resources reserved. For example, when the SCI-1 is transmitted in a slot along with an SCI-2 and a TB, the SCI-1 may include code points (e.g., one or more bits, or a combination of bits) for a modulation and coding scheme (MCS), an SCI-2 format, a beta offset, and/or a DMRS pattern. The SCI-1 transmitted in the resources reserved for repeating the SCI-1 transmission may use one or more of the code points utilized for the MCS (e.g., reserved code points in MCS indexes 28-31), the SCI-2 format, the beta offset, and/or the DMRS pattern to indicate that only the SCI-1 is being transmitted in the PSCCH and/or that the UE 115b may refrain from attempting to decode the contents of a PSSCH.

The UE 115b may determine the identifiers associated with other UEs and only monitor the reserved resources of the SCI-1 RP associated with UEs that are nearby the UE 115b (e.g., the UEs 115a, 115c). Additionally or alternatively, the UE 115b may only monitor the SCI-1 reserved resources associated with delay sensitive TBs. In some aspects, only a subset of TBs transmitted by the UE 115a may be delay sensitive. In some instances, the UE 115b may determine which TBs are delay sensitive and monitor only the reserved resources associated with a delay sensitive TB. In some instances, the UE 115b may receive an indicator from the UE 115a indicating whether the TB is delay sensitive. The indicator may be included the SCI-2 transmitted at 540. For example, the indicator may include one or more bits in a field of the SCI-2 (e.g., a code point in the SCI-2) to indicate whether the TB is delay sensitive.

At 560, the UE 115a may repeat the transmission of the SCI-1 in a second set of resources configured in the RP dedicated to the repeat transmission of the SCI-1. The SCI-1 may indicate resources reserved for potential retransmission of the delay sensitive TB in order to increase the probability that the delay sensitive TB will be received within a packet delay budget. Repeating the transmission of the SCI-1 for a second time at 560 may increase the probability of the UE 115b decoding the SCI-1.

At 570, the UE 115a may repeat the transmission of the delay sensitive TB based on whether the TB was successfully decoded by the UE 115c. In this regard, the UE 115c may transmit an ACK message in a HARQ process to indicate the delay sensitive TB was successfully decoded by the UE 115c. In this case, the UE 115a will refrain from retransmitting the delay sensitive TB. In some aspects, the UE 115c may transmit a NACK message in the HARQ process to indicate the delay sensitive TB was not successfully decoded by the UE 115c. In this case, the UE 115a will retransmit the delay sensitive TB.

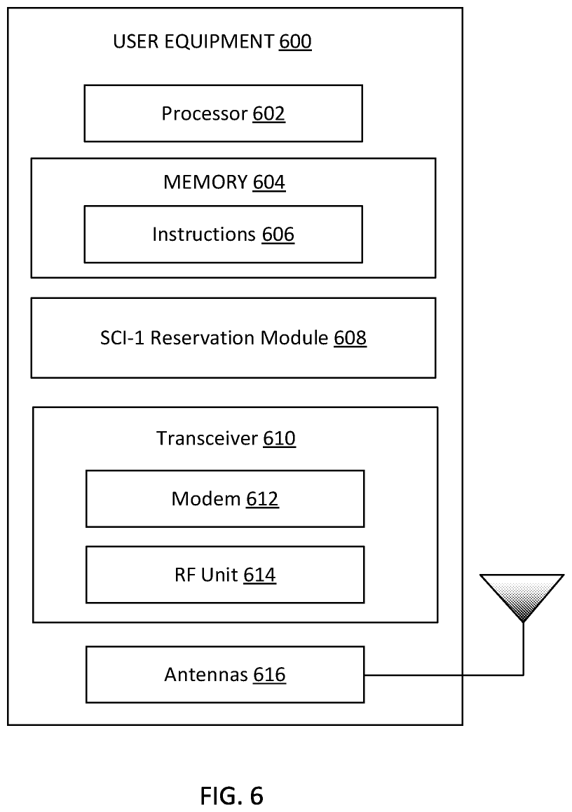

FIG. 6 is a block diagram of an exemplary UE 600 according to some aspects of the present disclosure. The UE 600 may be the UE 115 in the network 100 as discussed above. As shown, the UE 600 may include a processor 602, a memory 604, a SCI-1 reservation module 608, a transceiver 610 including a modem subsystem 612 and a radio frequency (RF) unit 614, and one or more antennas 616. These elements may be coupled with each other and in direct or indirect communication with each other, for example via one or more buses.

The processor 602 may include a central processing unit (CPU), a digital signal processor (DSP), an application specific integrated circuit (ASIC), a controller, a field programmable gate array (FPGA) device, another hardware device, a firmware device, or any combination thereof configured to perform the operations described herein. The processor 602 may also be implemented as a combination of computing devices, e.g., a combination of a DSP and a microprocessor, a plurality of microprocessors, one or more microprocessors in conjunction with a DSP core, or any other such configuration.

The memory 604 may include a cache memory (e.g., a cache memory of the processor 602), random access memory (RAM), magnetoresistive RAM (MRAM), read-only memory (ROM), programmable read-only memory (PROM), erasable programmable read only memory (EPROM), electrically erasable programmable read only memory (EEPROM), flash memory, solid state memory device, hard disk drives, other forms of volatile and non-volatile memory, or a combination of different types of memory. In some instances, the memory 604 includes a non-transitory computer-readable medium. The memory 604 may store instructions 606. The instructions 606 may include instructions that, when executed by the processor 602, cause the processor 602 to perform the operations described herein with reference to the UEs 115 in connection with aspects of the present disclosure, for example, aspects of FIGS. 2-5 and 8-9. Instructions 606 may also be referred to as code. The terms “instructions” and “code” should be interpreted broadly to include any type of computer-readable statement(s). For example, the terms “instructions” and “code” may refer to one or more programs, routines, sub-routines, functions, procedures, etc. “Instructions” and “code” may include a single computer-readable statement or many computer-readable statements.

The SCI-1 reservation module 608 may be implemented via hardware, software, or combinations thereof. For example, the SCI-1 reservation module 608 may be implemented as a processor, circuit, and/or instructions 606 stored in the memory 604 and executed by the processor 602.

The SCI-1 reservation module 608 may be used for various aspects of the present disclosure, for example, aspects of FIGS. 2-5 and 8-9. The SCI-1 reservation module 608 may reserve resources for the repeated transmission of the SCI-1. In some aspects, the SCI-1 reservation module 608 may repeat the transmission of the SCI-1. In some aspects, the SCI-1 reservation module 608 may receive and/or transmit an RP configuration that indicates the reserved resources for the repeated transmission of the SCI-1. In some aspects, the SCI-1 reservation module 608 may monitor resources indicated in the RP for the retransmission of the SCI-1.

As shown, the transceiver 610 may include the modem subsystem 612 and the RF unit 614. The transceiver 610 can be configured to communicate bi-directionally with other devices, such as the BSs 105 and/or the UEs 115. The modem sub system 612 may be configured to modulate and/or encode the data from the memory 604 and the SCI-1 reservation module 608 according to a modulation and coding scheme (MCS), e.g., a low-density parity check (LDPC) coding scheme, a turbo coding scheme, a convolutional coding scheme, a digital beamforming scheme, etc. The RF unit 614 may be configured to process (e.g., perform analog to digital conversion or digital to analog conversion, etc.) modulated/encoded data from the modem subsystem 612 (on outbound transmissions) or of transmissions originating from another source such as a UE 115 or a BS 105. The RF unit 614 may be further configured to perform analog beamforming in conjunction with the digital beamforming. Although shown as integrated together in transceiver 610, the modem subsystem 612 and the RF unit 614 may be separate devices that are coupled together to enable the UE 600 to communicate with other devices.

The RF unit 614 may provide the modulated and/or processed data, e.g. data packets (or, more generally, data messages that may contain one or more data packets and other information), to the antennas 616 for transmission to one or more other devices. The antennas 616 may further receive data messages transmitted from other devices. The antennas 616 may provide the received data messages for processing and/or demodulation at the transceiver 610. The antennas 616 may include multiple antennas of similar or different designs in order to sustain multiple transmission links. The RF unit 614 may configure the antennas 616.

In some instances, the UE 600 can include multiple transceivers 610 implementing different RATs (e.g., NR and LTE). In some instances, the UE 600 can include a single transceiver 610 implementing multiple RATs (e.g., NR and LTE). In some instances, the transceiver 610 can include various components, where different combinations of components can implement RATs.

In some aspects, the processor 602 may be coupled to the memory 604, the SCI-1 reservation module 608, and/or the transceiver 610. The processor 602 and may execute operating system (OS) code stored in the memory 604 in order to control and/or coordinate operations of the SCI-1 reservation module 608 and/or the transceiver 610. In some aspects, the processor 602 may be implemented as part of the SCI-1 reservation module 608

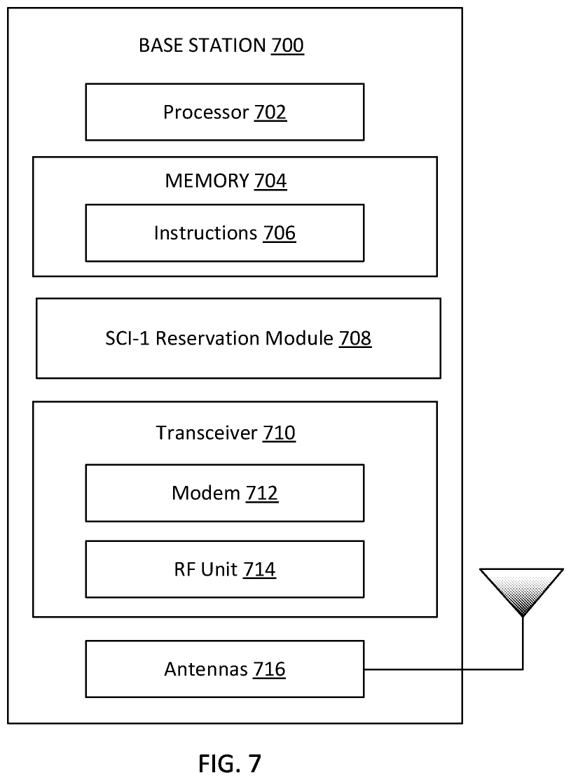

FIG. 7 is a block diagram of an exemplary BS 700 according to some aspects of the present disclosure. The BS 700 may be a BS 105 as discussed above. As shown, the BS 700 may include a processor 702, a memory 704, a SCI-1 reservation module 708, a transceiver 710 including a modem subsystem 712 and a RF unit 714, and one or more antennas 716. These elements may be coupled with each other and in direct or indirect communication with each other, for example via one or more buses.

The processor 702 may have various features as a specific-type processor. For example, these may include a CPU, a DSP, an ASIC, a controller, a FPGA device, another hardware device, a firmware device, or any combination thereof configured to perform the operations described herein. The processor 702 may also be implemented as a combination of computing devices, e.g., a combination of a DSP and a microprocessor, a plurality of microprocessors, one or more microprocessors in conjunction with a DSP core, or any other such configuration.

The memory 704 may include a cache memory (e.g., a cache memory of the processor 702), RAM, MRAM, ROM, PROM, EPROM, EEPROM, flash memory, a solid state memory device, one or more hard disk drives, memristor-based arrays, other forms of volatile and non-volatile memory, or a combination of different types of memory. In some instances, the memory 704 may include a non-transitory computer-readable medium. The memory 704 may store instructions 706. The instructions 706 may include instructions that, when executed by the processor 702, cause the processor 702 to perform operations described herein, for example, aspects of FIGS. 2-5 and 8-9. Instructions 706 may also be referred to as code, which may be interpreted broadly to include any type of computer-readable statement(s).

The SCI-1 reservation module 708 may be implemented via hardware, software, or combinations thereof. For example, the SCI-1 reservation module 708 may be implemented as a processor, circuit, and/or instructions 706 stored in the memory 704 and executed by the processor 702.

The SCI-1 reservation module 708 may be used for various aspects of the present disclosure, for example, aspects of FIGS. 2-5 and 8-9. The SCI-1 reservation module 708 is configured to transmit a resource pool configuration that indicates resources reserved for the repeated transmission of an SCI-1.

Additionally or alternatively, the SCI-1 reservation module 708 can be implemented in any combination of hardware and software, and may, in some implementations, involve, for example, processor 702, memory 704, instructions 706, transceiver 710, and/or modem 712.

As shown, the transceiver 710 may include the modem subsystem 712 and the RF unit 714. The transceiver 710 can be configured to communicate bi-directionally with other devices, such as the UEs 115 and/or 600. The modem subsystem 712 may be configured to modulate and/or encode data according to a MCS, e.g., a LDPC coding scheme, a turbo coding scheme, a convolutional coding scheme, a digital beamforming scheme, etc. The RF unit 714 may be configured to process (e.g., perform analog to digital conversion or digital to analog conversion, etc.) modulated/encoded data from the modem subsystem 712 (on outbound transmissions) or of transmissions originating from another source such as a UE 115 or UE 600. The RF unit 714 may be further configured to perform analog beamforming in conjunction with the digital beamforming. Although shown as integrated together in transceiver 710, the modem subsystem 712 and/or the RF unit 714 may be separate devices that are coupled together at the BS 700 to enable the BS 700 to communicate with other devices.

The RF unit 714 may provide the modulated and/or processed data, e.g. data packets (or, more generally, data messages that may contain one or more data packets and other information), to the antennas 716 for transmission to one or more other devices. This may include, for example, a message instructing the sub-slot-based UE to transmit a power reservation signal in an AGC symbol location of a slot RP according to aspects of the present disclosure. The antennas 716 may further receive data messages transmitted from other devices and provide the received data messages for processing and/or demodulation at the transceiver 710. The antennas 716 may include multiple antennas of similar or different designs in order to sustain multiple transmission links.

In some instances, the BS 700 can include multiple transceivers 710 implementing different RATs (e.g., NR and LTE). In some instances, the BS 700 can include a single transceiver 710 implementing multiple RATs (e.g., NR and LTE). In some instances, the transceiver 710 can include various components, where different combinations of components can implement RATs.

In some aspects, the processor 702 may be coupled to the memory 704, the SCI-1 reservation module 708, and/or the transceiver 710. The processor 702 may execute OS code stored in the memory 704 to control and/or coordinate operations of the SCI-1 reservation module 708, and/or the transceiver 710. In some aspects, the processor 702 may be implemented as part of the SCI-1 reservation module 708.

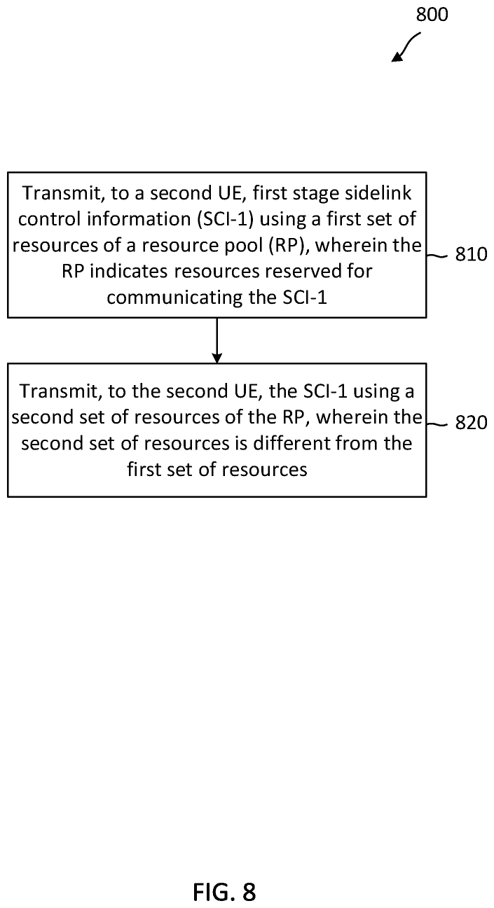

FIG. 8 is a flow diagram of a communication method 800 according to some aspects of the present disclosure. Aspects of the method 800 can be executed by a computing device (e.g., a processor, processing circuit, and/or other suitable component) of a wireless communication device or other suitable means for performing the aspects. For example, a wireless communication device, such as the UE 115 or UE 600, may utilize one or more components, such as the processor 602, the memory 604, the SCI-1 reservation module 608, the transceiver 610, the modem 612, and the one or more antennas 616, to execute aspects of method 800. The method 800 may employ similar mechanisms as in the networks 100 and 200 and the aspects and actions described with respect to FIGS. 2-5. As illustrated, the method 800 includes a number of enumerated steps, but the method 800 may include additional steps before, after, and in between the enumerated steps. In some aspects, one or more of the enumerated steps may be omitted or performed in a different order.

At 810, the method 800 includes a UE (e.g., the UE 115 or the UE 600) transmitting, to another UE, first stage sidelink control information (SCI-1) using a first set of resources of a resource pool (RP). In some instances, the RP indicates resources reserved for communicating the SCI-1. The RP may indicate time/frequency resources dedicated to repeating the transmission of the SCI-1 in a physical sidelink control channel (PSCCH). The transmission of the SCI-1 to another UE using the dedicated resources may be a repeat transmission of the SCI-1. For example, the UE may initially transmit a communication that includes the SCI-1, an SCI-2, and a delay sensitive transport block (TB). The SCI-1 may indicate resources reserved for potential retransmission of the delay sensitive TB in order to increase the probability that the delay sensitive TB will be received within a packet delay budget. The other UE may not receive and/or properly decode the communication that includes the SCI-1, the SCI-2, and the TB resulting in the other UE not respecting the resource reservation for the potential retransmission of the TB. The delay sensitive TB may be transmitted by an industrial Internet of things (IoTs) device (e.g., a meter, a programmable logic controller, a sensor, a robot, an actuator, etc.) and/or a vehicle-to-everything (V2X) device. The IoT or V2X devices may communicate data in TBs that is time delay sensitive and/or requires high reliability. For example, a UE such as sensor of a robot may need to transmit sensor data to a controller in real time. As another example, a vehicle may need to transmit safety related data to another vehicle in real time. The time delay sensitive TBs may have a packet delay budget in which the TB needs to be received based on the context or application. In the case of the robot sensor, the packet budget delay may be a number of milliseconds. In the case of a vehicle transmitting safety related data to another vehicle, the packet delay budget may be hundreds of milliseconds or seconds. However, in both examples, there may be a requirement for a reliable transmission of the TB. Aspects of the present disclosure may provide methods of increasing the probability that the other UE receives the SCI-1. For example, the UE may repeat the transmission of the SCI-1 using the resources in the RP dedicated to the SCI-1. In some aspects, the UE may repeat the transmission of the SCI-1 multiple times further increasing the probability that the other UE will receive, decode, and respect the resource reservations in the SCI-1 thus increasing the reliability of the TB transmission.

In some aspects, the UE may receive an RP configuration that includes and/or configures the RP. The UE may receive the RP configuration from a BS (e.g., the BS 105 or the BS 700). In this regard, the UE may receive the RP configuration from the BS via at least one of radio resource control (RRC) signaling, PDCCH signaling, or media access control (MAC) control element (CE) signaling. The RP configuration may include, without limitation, a location (e.g., time and/or frequency) of the resource elements dedicated to the repeat transmission of the SCI-1. In some aspects, the UE may receive the RP configuration from another UE (e.g., the UE 115 or the UE 600). In this regard, the UE may receive the RP configuration from another UE via at least one of a physical sidelink control channel (PSCCH), an SCI-1, an SCI-2, a physical sidelink shared channel (PSSCH), physical sidelink broadcast channel (PSBCH) communications, physical downlink control channel (PDCCH) communications, physical downlink shared channel (PDSCH) communications, physical broadcast channel (PBCH) communications and/or other types of sidelink communications. In some aspects, the UE may transmit the RP configuration to another UE.

The RP configuration may include a location (e.g., time and/or frequency) of the resource elements dedicated to the repeat transmission of the SCI-1. The RP configuration may further indicate one or more sets of resources that can be utilized for transmitting the SCI-1. For example, in some instances the RP configuration may indicate a first set of resources for transmitting a first repetition of the SCI-1 and a second set of resources for transmitting a second repetition of the SCI-1. The UE may transmit the SCI-1 in the first set of resources and transmit (e.g., retransmit) the SCI-1 in the second set of resources. The resources may include time domain resources that include certain symbols, slots, and/or sub-slots reserved for the SCI-1. The resources may include frequency domain resources that include a certain frequency, a range of frequencies, a subchannel(s), or subband(s) reserved for the transmission of the SCI-1. For example, the RP configuration for the SCI-1 may include a mapping of the first set of resources to a first sub-slot of a first slot and a first frequency range. The RP configuration may further include a mapping of the second set of resources to a second sub-slot of a second slot and a second frequency range. The second sub-slot may be different from the first sub-slot. The second frequency range may be different from the first frequency range. In some instances, the second slot may follow (e.g., immediately follow) the first slot to increase the probability that other UEs will receive the repeated SCI-1s. In some aspects, the UE may transmit any number of repeated SCI-1s. For examples, the UE may transmit the SCI-1 in a third set of resources, a fourth set of resources, etc. Each repeated transmission of the SCI-1 may be repeated within a window of time starting from the transmission of the delay sensitive TB to the end of the packet delay budget associated with the delay sensitive TB.

The RP configuration may indicate a location of each set of time domain resources reserved for repeating the SCI-1 transmission. For example, the set of time domain resources may include a sub-slot. In some aspects, a slot may be partitioned in the time domain into sub-slots. Each of the sub-slots may include at least one symbol. In this regard, each sub-slot may include 1, 2, 3, 4, 5 or more symbols. In some instances, a sub-slot may include symbols for an automatic gain control (AGC) signal, a PSCCH (e.g., to carry the SCI-1), and a gap period. For example, the sub-slot may include the AGC signal mapped to the leading symbol, the PSCCH mapped to one or two symbols following the leading symbol, and the gap symbol mapped to the last symbol of the sub-slot and/or any symbol(s) following the PSCCH symbol(s). The RP configuration may also indicate a location of the frequency domain resources reserved for repeating the SCI-1 transmission. For example, the RP may indicate a number of frequency subchannels, subbands, or ranges of frequencies reserved for the PSCCH for carrying the repeated SCI-1. In some aspects, the RP may indicate the same frequency resources (e.g., the same subchannels, subbands, or ranges of frequencies) reserved for the PSCCH for carrying the repeated SCI-1 but different time domain resources. In some aspects, the time domain resources may indicate the same symbols within a slot or sub-slot while indicating a different slot or sub-slot. The time domain resources may be consecutive in time to increase the probability of the repeated SCI-1 being received by the other UE(s).

In some aspects, the resources reserved for the SCI-1 may be indexed. In this regard, each value of the index may be associated with a set of time resources (e.g., a set of symbols) and/or a set of frequency resources (e.g., a number of frequency subchannels, subbands, and/or a range of frequencies). The index may be used by the UE to determine and/or locate the resources dedicated to the repeated transmission of the SCI-1. The index value may be determined using any suitable method. For example, in some instances the index value may be determined by a hashing function of an index value associated with a slot in which the set of resources are located and a resource identifier. The resource identifier may be based on a UE identifier associated with the UE that transmits the delay sensitive TB and/or a UE identifier associated with the UE that monitors for the repeated SCI-1. In some aspects, the resource identifier may be based on a link identifier. The link identifier may be based on the UE identifier associated with the UE that transmits the delay sensitive TB and the UE that monitors for the repeated SCI-1. In this regard, the link identifier may be a concatenation of a portion of the UE identifier associated with the UE that transmits the delay sensitive TB and a portion of the UE identifier of the UE that monitors for the repeated SCI-1.

In some aspects, the UE that transmits the delay sensitive TB may determine a set of candidate resource index values associated with the resources dedicated to the repeated transmission of the SCI-1. The UE may determine the set of candidate resource index values based on a hashing function of an index value associated with a slot in which the resources are located, the number of candidate resources, the number of sub-slots in the slot, and the link identifier. The hashing function may generate a different set of candidate resource index values for each slot. The UE may select a resource index value from the set of candidate resource index values for other UEs to monitor for the repeated SCI-1s.

At 820, the method 800 includes the UE transmitting, to the other UE, the SCI-1 using a second set of resources of the RP. In some instances, the second set of resources is different from the first set of resources. In some instances, the RP indicates resources reserved for communicating the SCI-1. The RP may indicate time/frequency resources dedicated to repeating the transmission of the SCI-1 in a physical sidelink control channel (PSCCH). The transmission of the SCI-1 to another UE using the dedicated resources may be a repeat transmission of the SCI-1. For example, the UE may initially transmit a communication that includes the SCI-1, an SCI-2, and a delay sensitive transport block (TB). The SCI-1 may indicate resources reserved for potential retransmission of the delay sensitive TB in order to increase the probability that the delay sensitive TB will be received within a packet delay budget. In some aspects, the UE may receive an RP configuration that includes and/or configures the RP as described above at 810.

In some aspects, the UE may initially transmit the SCI-1 in a PSCCH and the delay sensitive TB in a PSSCH within a slot. In some instances, the other UE may be a half-duplex UE that is capable of transmitting and receiving but not simultaneously transmitting and receiving. The other UE may not receive and/or properly decode the SCI-1 from the initial transmission because the other UE may be transmitting during the time that the SCI-1 is transmitted and be unable to simultaneously receive while transmitting. The SCI-1 may indicate resources reserved for future transmission and/or retransmission of TBs. For example, the SCI-1 may include a time domain resource allocation (TDRA) and/or a frequency domain resource allocation (FDRA) associated future transmission and/or retransmission of TBs. Since the other UE does not receive and decode the SCI-1, the other UE may not respect the resource reservation indicated by the SCI-1. Repeating the transmission of the SCI-1 may increase the probability that the other UE correctly receives and decodes the SCI-1 and respects the resources reserved for future transmissions or retransmissions.

The delay sensitive TB may have a packet delay budget that indicates a time in which the TB should be received by its intended UE receiver. If the delay sensitive TB is not correctly received and decoded by the intended UE receiver, the delay sensitive TB may be retransmitted by the UE in the reserved resources indicated by the SCI-1. Therefore, repeating the transmission of the SCI-1 in a separate and dedicated RP may increase the probability that the resources reserved for the retransmission of the delay sensitive TB will be respected by the other UE(s) to avoid transmission collisions in the reserved resource. In some aspects, the time between the UE transmitting the initial SCI-1 and the repeated SCI-Is may be based on the packet delay budget associated with the TB. For example, the UE may repeat the transmission of the SCI-1s in one or more sub-slots in one or more slots adjacent to the initial transmission (e.g., a consecutive transmission of the initial SCI-1 and the repeated transmissions of the SCI-1). In some aspects, multiple UEs may each transmit delay sensitive TBs and each of the multiple UEs may transmit repeated SCI-1s for one or more of their respective delay sensitive TBs.

In some aspects, the SCI-1 transmitted in the reserved resources may include an indicator that indicates that physical sidelink shared channel (PSSCH) decoding is not required. The repeated transmission of the SCI-1 in the reserved resources may include transmission of the SCI-1 in a PSCCH, an automatic gain control (AGC) symbol, and a gap symbol. The repeated transmission of the SCI-1 in the reserved resources may exclude a PSSCH. The SCI-1 may indicate that only the SCI-1 is being transmitted in the PSCCH and the UE may refrain from attempting to decode the contents of an associated PSSCH. The UE receiving the SCI-1 may reduce power consumption by refraining from attempting to decode the contents of the associated PSSCH. The indicator that indicates PSSCH decoding is not required may include any suitable indicator (e.g., a code point, a flag, a parameter value, etc.). For example, the indicator may include one or more code points that are used for other purposes when the SCI-1 is transmitted in a slot outside of the resources reserved. For example, when the SCI-1 is transmitted in a slot along with an SCI-2 and a TB, the SCI-1 may include code points (e.g., one or more bits, or a combination of bits) for a modulation and coding scheme (MCS), an SCI-2 format, a beta offset, and/or a DMRS pattern. The SCI-1 transmitted in the resources reserved for repeating the SCI-1 transmission may use one or more of the code points utilized for the MCS (e.g., reserved code points in MCS indexes 28-31), the SCI-2 format, the beta offset, and/or the DMRS pattern to indicate that only the SCI-1 is being transmitted in the PSCCH and/or that the UE may refrain from attempting to decode the contents of a PSSCH.

In some aspects, the RP configuration may be based, at least in part, on network conditions. For example, in some aspects the RP configuration may be based on a distance between the transmitting UE and the receiving UE(s). In some aspects, a UE monitoring the dedicated SCI-1 RP may monitor all resources within the RP. However, monitoring all the resources in the RP may consume an excessive amount of computing resources and/or power. In some aspects, the UE monitoring the dedicated SCI-1 RP may monitor only the resources within the RP that are associated with UEs that are within a threshold distance to the monitoring UE. For example, the monitoring UE may determine the identifiers associated with the UEs within the threshold distance and only monitor the resources associated with those UE identifiers. The threshold distance may be based on signal strength, physical distance, and/or other parameters. The monitoring UE may determine which UEs are within the threshold distance using any suitable method. For example, the monitoring UE may measure a received signal strength from other UEs and determine if a received signal strength indicator (RSSI) satisfies a threshold. For example, an RSSI value satisfying the threshold may include an RSSI value greater than −80 dBm, greater than −60 dBm, greater than −40 dBm, or greater than −20 dBm. In some aspects, the UE may receive a communication from a BS indicating the identifiers of the UEs that the UE should be monitoring the dedicated SCI-1 RP for communications from. In some aspects, the monitoring UEs may determine identifiers of the UEs within the threshold distance by monitoring the SCI-2 transmissions from the other UEs. The SCI-2 may include a source identifier that identifies the UE transmitting the SCI-2.

As described above, a monitoring UE may determine the identifiers associated with other UEs and only monitor the reserved resources of the SCI-1 RP associated with UEs that are nearby the monitoring UE. Additionally or alternatively, the monitoring UEs may only monitor the SCI-1 reserved resources associated with delay sensitive TBs. In some aspects, only a subset of TBs transmitted by a UE may be delay sensitive. In some instances, a monitoring UE may determine which TBs are delay sensitive and monitor only the reserved resources associated with a delay sensitive TB. In some instances, the monitoring UE may receive an indicator from the UE transmitting the TB indicating whether the TB is delay sensitive. The indicator may be included the SCI-2 of the UE transmitting the TB. For example, the indicator may include one or more bits in a field of the SCI-2 (e.g., a code point in the SCI-2) to indicate whether the TB is delay sensitive.

Additionally or alternatively, the UE may repeat the SCI-1 transmission in a subsequent communication within a slot that is not located in the dedicated SCI-1 RP. For example, the UE may transmit a first communication in a first slot that includes a first SCI-1 and a delay sensitive TB. The UE may subsequently transmit a second communication in a second slot that includes a second SCI-1 and a second TB different from the delay sensitive TB. The first SCI-1 in the first communication in the first slot may indicate resources reserved for the potential retransmission of the delay sensitive TB. The second SCI-1 in the second communication in the second slot may indicate the resources reserved for the potential retransmission of the delay sensitive TB and the resources reserved for the potential retransmission of the second TB. However, the second SCI-1 in the second communication in the second slot may only indicate the resources reserved for the potential retransmission of the delay sensitive TB based on the transmission of the second communication being within the packet delay budget of the delay sensitive TB. In this way, the repeated transmission of the resources reserved for the potential retransmission of the delay sensitive TB in the second SCI-1 may increase the probability of other UEs respecting the resources reserved for the potential retransmission of the delay sensitive TB and increase the probability of a successful retransmission of the delay sensitive TB. In some aspects, the second SCI-1 transmitted in the second communication in the second slot may include an indicator that the second SCI-1 includes a repeat transmission of the resource reservation for the delay sensitive TB. In this regard, the indicator may include a combination of one or more bits in a field of the second SCI-1 (e.g., a code point in the SCI-1). For example, the code point may be included in the time domain resource allocation (TDRA) and/or the frequency domain resource allocation (FDRA).

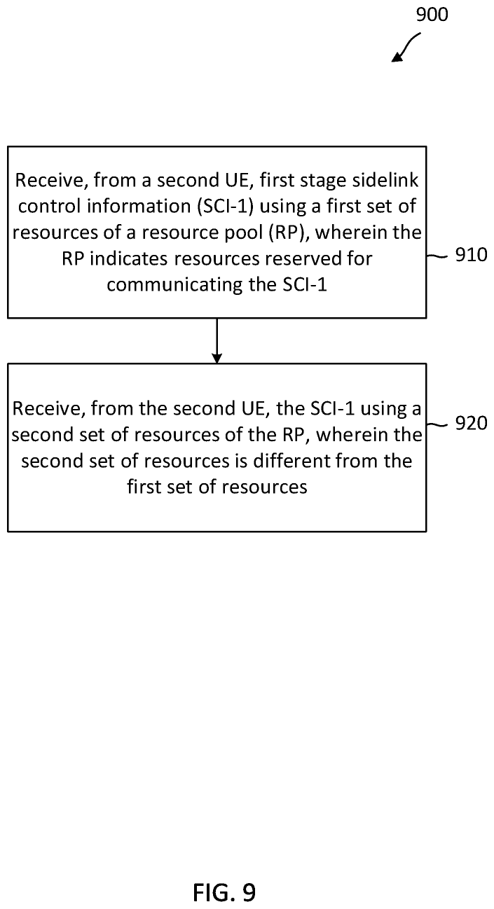

FIG. 9 is a flow diagram of a communication method 900 according to some aspects of the present disclosure. Aspects of the method 900 can be executed by a computing device (e.g., a processor, processing circuit, and/or other suitable component) of a wireless communication device or other suitable means for performing the aspects. For example, a wireless communication device, such as the UE 115 or UE 600, may utilize one or more components, such as the processor 602, the memory 604, the SCI-1 reservation module 608, the transceiver 610, the modem 612, and the one or more antennas 616, to execute aspects of method 900. The method 900 may employ similar mechanisms as in the networks 100 and 200 and the aspects and actions described with respect to FIGS. 2-5. As illustrated, the method 900 includes a number of enumerated steps, but the method 900 may include additional steps before, after, and in between the enumerated steps. In some aspects, one or more of the enumerated steps may be omitted or performed in a different order.

At 910, the method 900 includes a UE (e.g., the UE 115 or the UE 600) receiving from another UE, first stage sidelink control information (SCI-1) using a first set of resources of a resource pool (RP). In some instances, the RP indicates resources reserved for communicating the SCI-1. The RP may indicate time/frequency resources dedicated to repeating the transmission of the SCI-1 in a physical sidelink control channel (PSCCH). The transmission of the SCI-1 to another UE using the dedicated resources may be a repeat transmission of the SCI-1. For example, the transmitting UE may initially transmit a communication that includes the SCI-1, an SCI-2, and a delay sensitive transport block (TB). The SCI-1 may indicate resources reserved for potential retransmission of the delay sensitive TB in order to increase the probability that the delay sensitive TB will be received within a packet delay budget. The intended receiving UE may not receive and/or properly decode the communication that includes the SCI-1, the SCI-2, and the TB resulting in the intended receiving UE not respecting the resource reservation for the potential retransmission of the TB. Aspects of the present disclosure may provide methods of increasing the probability that the intended receiving UE receives the SCI-1. For example, the transmitting UE may repeat the transmission of the SCI-1 using the resources in the RP dedicated to the SCI-1. In some aspects, the transmitting UE may repeat the transmission of the SCI-1 multiple times further increasing the probability that the intended receiving UE will receive, decode, and respect the resource reservations in the SCI-1 thus increasing the reliability of the TB transmission.

In some aspects, the UE may receive an RP configuration that includes and/or configures the RP. The UE may receive the RP configuration from a BS (e.g., the BS 105 or the BS 700). In this regard, the UE may receive the RP configuration from the BS via at least one of radio resource control (RRC) signaling, PDCCH signaling, or media access control (MAC) control element (CE) signaling. The RP configuration may include, without limitation, a location (e.g., time and/or frequency) of the resource elements dedicated to the repeat transmission of the SCI-1. In some aspects, the UE may receive the RP configuration from another UE (e.g., the UE 115 or the UE 600). In this regard, the UE may receive the RP configuration from another UE via at least one of a physical sidelink control channel (PSCCH), an SCI-1, an SCI-2, a physical sidelink shared channel (PSSCH), physical sidelink broadcast channel (PSBCH) communications, physical downlink control channel (PDCCH) communications, physical downlink shared channel (PDSCH) communications, physical broadcast channel (PBCH) communications and/or other types of sidelink communications. In some aspects, the UE may transmit the RP configuration to another UE.

The RP configuration may include a location (e.g., time and/or frequency) of the resource elements dedicated to the repeat transmission of the SCI-1. The RP configuration may further indicate one or more sets of resources that can be utilized for transmitting the SCI-1. For example, in some instances the RP configuration may indicate a first set of resources for transmitting a first repetition of the SCI-1 and a second set of resources for transmitting a second repetition of the SCI-1. The transmitting UE may transmit the SCI-1 in the first set of resources and transmit (e.g., retransmit) the SCI-1 in the second set of resources. The resources may include time domain resources that include certain symbols, slots, and/or sub-slots reserved for the SCI-1. The resources may include frequency domain resources that include a certain frequency, a range of frequencies, a subchannel(s), or subband(s) reserved for the transmission of the SCI-1. For example, the RP configuration for the SCI-1 may include a mapping of the first set of resources to a first sub-slot of a first slot and a first frequency range. The RP configuration may further include a mapping of the second set of resources to a second sub-slot of a second slot and a second frequency range. The second sub-slot may be different from the first sub-slot. The second slot may be different from the first slot. The second frequency range may be different from the first frequency range. In some instances, the second slot may follow (e.g., immediately follow) the first slot to increase the probability that other UEs will receive the repeated SCI-1s. In some aspects, the transmitting UE may transmit any number of repeated SCI-1s. For examples, the transmitting UE may transmit the SCI-1 in a third set of resources, a fourth set of resources, etc. Each repeated transmission of the SCI-1 may be repeated within a window of time starting from the transmission of the delay sensitive TB to the end of the packet delay budget associated with the delay sensitive TB.

The RP configuration may indicate a location of each set of time domain resources reserved for repeating the SCI-1 transmission. For example, the set of time domain resources may include a sub-slot. In some aspects, a slot may be partitioned in the time domain into sub-slots. Each of the sub-slots may include at least one symbol. In this regard, each sub-slot may include 1, 2, 3, 4, 5 or more symbols. In some instances, a sub-slot may include symbols for an automatic gain control (AGC) signal, a PSCCH (e.g., to carry the SCI-1), and a gap period. For example, the sub-slot may include the AGC signal mapped to the leading symbol, the PSCCH mapped to one or two symbols following the leading symbol, and the gap symbol mapped to the last symbol of the sub-slot and/or any symbol(s) following the PSCCH symbol(s). The RP configuration may also indicate a location of the frequency domain resources reserved for repeating the SCI-1 transmission. For example, the RP may indicate a number of frequency subchannels, subbands, or ranges of frequencies reserved for the PSCCH for carrying the repeated SCI-1. In some aspects, the RP may indicate the same frequency resources (e.g., the same subchannels, subbands, or ranges of frequencies) reserved for the PSCCH for carrying the repeated SCI-1 but different time domain resources. In some aspects, the time domain resources may indicate the same symbols within a slot or sub-slot while indicating a different slot or sub-slot. The time domain resources may be consecutive in time to increase the probability of the repeated SCI-1 being received by the other UE(s).

In some aspects, the resources reserved for the SCI-1 may be indexed. In this regard, each value of the index may be associated with a set of time resources (e.g., a set of symbols) and/or a set of frequency resources (e.g., a number of frequency subchannels, subbands, and/or a range of frequencies). The index may be used by the intended receiving UE to determine and/or locate the resources dedicated to the repeated transmission of the SCI-1. The index value may be determined using any suitable method. For example, in some instances the index value may be determined by a hashing function of an index value associated with a slot in which the set of resources are located and a resource identifier. The resource identifier may be based on a UE identifier associated with the UE that transmits the delay sensitive TB and/or a UE identifier associated with the intended receiving UE that monitors for the repeated SCI-1. In some aspects, the resource identifier may be based on a link identifier. The link identifier may be based on the UE identifier associated with the UE that transmits the delay sensitive TB and the intended receiving UE that monitors for the repeated SCI-1. In this regard, the link identifier may be a concatenation of a portion of the UE identifier associated with the UE that transmits the delay sensitive TB and a portion of the UE identifier of the intended receiving UE that monitors for the repeated SCI-1.

In some aspects, the UE that transmits the delay sensitive TB may determine a set of candidate resource index values associated with the resources dedicated to the repeated transmission of the SCI-1. The UE that transmits the delay sensitive TB may determine the set of candidate resource index values based on a hashing function of an index value associated with a slot in which the resources are located, the number of candidate resources, the number of sub-slots in the slot, and the link identifier. The hashing function may generate a different set of candidate resource index values for each slot. The UE may select a resource index valuefrom the set of candidate resource index values for other UEs to monitor for the repeated SCI-1s.

At 920, the method 900 includes the UE receiving, from the other UE, the SCI-1 using a second set of resources of the RP. In some instances, the second set of resources is different from the first set of resources. In some instances, the RP indicates resources reserved for communicating the SCI-1. The RP may indicate time/frequency resources dedicated to repeating the transmission of the SCI-1 in a physical sidelink control channel (PSCCH). The transmission of the SCI-1 to another UE using the dedicated resources may be a repeat transmission of the SCI-1. For example, the transmitting UE may initially transmit a communication that includes the SCI-1, an SCI-2, and a delay sensitive transport block (TB). The SCI-1 may indicate resources reserved for potential retransmission of the delay sensitive TB in order to increase the probability that the delay sensitive TB will be received within a packet delay budget. In some aspects, the UE may receive an RP configuration that includes and/or configures the RP as described above at 910.

In some aspects, the transmitting UE may initially transmit the SCI-1 in a PSCCH and the delay sensitive TB in a PSSCH within a slot. In some instances, the other UE (e.g., the intended receiver of the SCI-1) may be a half-duplex UE that is capable of transmitting and receiving but not simultaneously transmitting and receiving. The intended receiving UE may not receive and/or properly decode the SCI-1 from the initial transmission because the intended receiving UE may be transmitting during the time that the SCI-1 is transmitted and be unable to simultaneously receive while transmitting. The SCI-1 may indicate resources reserved for future transmission and/or retransmission of TBs. For example, the SCI-1 may include a time domain resource allocation (TDRA) and/or a frequency domain resource allocation (FDRA) associated future transmission and/or retransmission of TBs. Since the intended receiving UE does not receive and decode the SCI-1, the intended receiving UE may not respect the resource reservation indicated by the SCI-1. Repeating the transmission of the SCI-1 may increase the probability that the intended receiving UE and other UEs nearby correctly receive and decode the SCI-1 and respect the resources reserved for future transmissions or retransmissions.

The delay sensitive TB may have a packet delay budget that indicates a time in which the TB should be received by its intended UE receiver. If the delay sensitive TB is not correctly received and decoded by the intended UE receiver, the delay sensitive TB may be retransmitted by the UE in the reserved resources indicated by the SCI-1. Therefore, repeating the transmission of the SCI-1 in a separate and dedicated RP may increase the probability that the resources reserved for the retransmission of the delay sensitive TB will be respected by the other UE(s) to avoid transmission collisions in the reserved resource. In some aspects, the time between the UE transmitting the initial SCI-1 and the repeated SCI-1s may be based on the packet delay budget associated with the TB. For example, the UE may repeat the transmission of the SCI-Is in one or more sub-slots in one or more slots adjacent to the initial transmission (e.g., a consecutive transmission of the initial SCI-1 and the repeated transmissions of the SCI-1). In some aspects, multiple UEs may each transmit delay sensitive TBs and each of the multiple UEs may transmit repeated SCI-Is for one or more of their respective delay sensitive TBs.

In some aspects, the SCI-1 transmitted in the reserved resources may include an indicator that indicates that physical sidelink shared channel (PSSCH) decoding is not required. The repeated transmission of the SCI-1 in the reserved resources may include transmission of the SCI-1 in a PSCCH, an automatic gain control (AGC) symbol, and a gap symbol. The repeated transmission of the SCI-1 in the reserved resources may exclude a PSSCH. The SCI-1 may indicate that only the SCI-1 is being transmitted in the PSCCH and the UE may refrain from attempting to decode the contents of an associated PSSCH. The UE receiving the SCI-1 may reduce power consumption by refraining from attempting to decode the contents of the associated PSSCH.

In some aspects, the RP configuration may be based, at least in part, on network conditions. For example, in some aspects the RP configuration may be based on a distance between the transmitting UE and the intended receiving UE(s) monitoring for the SCI-1. In some aspects, a UE monitoring the dedicated SCI-1 RP may monitor all resources within the RP. However, monitoring all the resources in the RP may consume an excessive amount of computing resources and/or power. In some aspects, the UE monitoring the dedicated SCI-1 RP may monitor only the resources within the RP that are associated with UEs that are within a threshold distance to the monitoring UE.

As described above, a monitoring UE may determine the identifiers associated with other UEs and only monitor the reserved resources of the SCI-1 RP associated with UEs that are nearby the monitoring UE. Additionally or alternatively, the monitoring UEs may only monitor the SCI-1 reserved resources associated with delay sensitive TBs. In some aspects, only a subset of TBs transmitted by a UE may be delay sensitive. In some instances, a monitoring UE may determine which TBs are delay sensitive and monitor only the reserved resources associated with a delay sensitive TB.

Additionally or alternatively, the transmitting UE may repeat the SCI-1 transmission in a subsequent communication within a slot that is not located in the dedicated SCI-1 RP. For example, the transmitting UE may transmit a first communication in a first slot that includes a first SCI-1 and a delay sensitive TB. The transmitting UE may subsequently transmit a second communication in a second slot that includes a second SCI-1 and a second TB different from the delay sensitive TB. The first SCI-1 in the first communication in the first slot may indicate resources reserved for the potential retransmission of the delay sensitive TB. The second SCI-1 in the second communication in the second slot may indicate the resources reserved for the potential retransmission of the delay sensitive TB and the resources reserved for the potential retransmission of the second TB. However, the second SCI-1 in the second communication in the second slot may only indicate the resources reserved for the potential retransmission of the delay sensitive TB based on the transmission of the second communication being within the packet delay budget of the delay sensitive TB. In this way, the repeated transmission of the resources reserved for the potential retransmission of the delay sensitive TB in the second SCI-1 may increase the probability of other UEs respecting the resources reserved for the potential retransmission of the delay sensitive TB and increase the probability of a successful retransmission of the delay sensitive TB.

By way of non-limiting examples, the following aspects are included in the present disclosure.

Aspect 1 includes a method of wireless communication performed by a first user equipment (UE), the method comprising transmitting, to a second UE, first stage sidelink control information (SCI-1) using a first set of resources of a resource pool (RP), wherein the RP indicates resources reserved for communicating the SCI-1; and transmitting, to the second UE, the SCI-1 using a second set of resources of the RP, wherein the second set of resources is different from the first set of resources.

Aspect 2 includes the method of aspect 1, further comprising receiving, from a base station (BS), an RP configuration that indicates the RP.

Aspect 3 includes the method of any of aspects 1-2, further comprising receiving, from a third UE, an RP configuration that indicates the RP.

Aspect 4 includes the method of any of aspects 1-3, further comprising transmitting, to the second UE, a configuration that indicates a location of at least one of the first set of resources or the second set of resources.

Aspect 5 includes the method of any of aspects 1-4, wherein the configuration is based on a distance between the first UE and the second UE.

Aspect 6 includes the method of any of aspects 1-5, wherein at least one of the first set of resources or the second set of resources is based on an identifier associated with the first UE.

Aspect 7 includes the method of any of aspects 1-6, wherein the SCI-1 indicates resources reserved for communicating one or more transport blocks.

Aspect 8 includes the method of any of aspects 1-7, further comprising transmitting the SCI-1 in a first slot; transmitting the SCI-1 in a second slot, wherein the first slot is different from the second slot.

Aspect 9 includes the method of any of aspects 1-8, further comprising transmitting a transport block (TB) in the first slot, wherein a resource reservation associated with the first TB is based on a packet delay budget associated with the first TB.

Aspect 10 includes the method of any of aspects 1-9, wherein the SCI-1 comprises at least one of a time domain resource allocation (TDRA) or a frequency domain resource allocation (FDRA) associated with a transport block (TB).

Aspect 11 includes the method of any of aspects 1-10, wherein the SCI-1 indicates that physical sidelink shared channel (PSSCH) decoding is not required.

Aspect 12 includes the method of any of aspects 1-11, further comprising mapping the first set of resources to a first slot and a first frequency range; and mapping the second set of resources to a second slot and a second frequency range, wherein the second slot is different from the first slot; and the second frequency range is different from the first frequency range.

Aspect 13 includes the method of any of aspects 1-12, further comprising mapping the first set of resources to a sub-slot of a plurality of sub-slots of a first slot; and mapping the second set of resources to a sub-slot of a plurality of sub-slots of a second slot, wherein the second slot is different from the first slot.

Aspect 14 includes the method of any of aspects 1-13, further comprising selecting at least one of a time domain index or a frequency domain index associated with the first set of resources based on at least one of a slot identifier associated with the first set of resources; a sub-slot identifier associated with the first set of resources; an identifier associated with the first UE; or an identifier associated with the second UE.

Aspect 15 includes the method of any of aspects 1-14, further comprising selecting at least one of a candidate set of time domain indexes or a candidate set of frequency domain indexes associated with the first set of resources based on at least one of a slot identifier associated with the first set of resources; a sub-slot identifier associated with the first set of resources; an identifier associated with the first UE; an identifier associated with the second UE; a total number of time domain resources in the RP; or a total number of frequency resources in the RP, and selecting the first set of resources based on at least one of the candidate set of time domain indexes or the candidate set of frequency domain indexes.

Aspect 16 includes a method of wireless communication performed by a first user equipment (UE), the method comprising receiving, from a second UE, first stage sidelink control information (SCI-1) using a first set of resources of a resource pool (RP), wherein the RP indicates resources reserved for communicating the SCI-1; and receiving, from the second UE, the SCI-1 using a second set of resources of the RP, wherein the second set of resources is different from the first set of resources.

Aspect 17 includes the method of aspect 16, wherein the receiving the SCI-1 using the first set of resources and the second set of resources is based on a received signal strength indicator (RSSI) associated with the second UE.

Aspect 18 includes the method of any of aspects 16-17, further comprising receiving, from the second UE, second stage sidelink control information (SCI-2); and decoding, from the SCI-2, an identifier associated with the second UE, wherein the receiving the SCI-1 using the first set of resources and the second set of resources is based on the identifier associated with the second UE.

Aspect 19 includes the method of any of aspects 16-18, further comprising receiving, from the second UE, second stage sidelink control information (SCI-2); and decoding, from the SCI-2, an indicator that indicates whether the UE should receive the SCI-1, wherein the receiving the SCI-1 using the first set of resources and the second set of resources is based on the indicator.

Aspect 20 includes the method of any of aspects 16-19, wherein the indicator is based on a packet delay budget associated with a transport block transmitted by the second UE.

Aspect 21 includes a user equipment (UE) comprising a transceiver, a memory, and a processor coupled to the transceiver and the memory, the UE configured to perform any one of aspects 1-15.

Aspect 22 includes a user equipment (UE) comprising a transceiver, a memory, and a processor coupled to the transceiver and the memory, the UE configured to perform any one of aspects 16-20.

Aspect 23 includes a non-transitory computer-readable medium storing one or more instructions for wireless communication, the one or more instructions comprising one or more instructions that, when executed by one or more processors of a user equipment, cause the one or more processors to perform any one of aspects 1-15.

Aspect 24 includes a non-transitory computer-readable medium storing one or more instructions for wireless communication, the one or more instructions comprising one or more instructions that, when executed by one or more processors of a user equipment, cause the one or more processors to perform any one of aspects 16-20.

Aspect 25 includes a user equipment (UE) comprising one or more means to perform any one or more of aspects 1-15.

Aspect 26 includes a user equipment (UE) comprising one or more means to perform any one or more of aspects 16-20.

Information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items (for example, a list of items prefaced by a phrase such as “at least one of” or “one or more of”) indicates an inclusive list such that, for example, a list of [at least one of A, B, or C] means A or B or C or AB or AC or BC or ABC (i.e., A and B and C).

As those of some skill in this art will by now appreciate and depending on the particular application at hand, many modifications, substitutions and variations can be made in and to the materials, apparatus, configurations and methods of use of the devices of the present disclosure without departing from the spirit and scope thereof. In light of this, the scope of the present disclosure should not be limited to that of the particular instances illustrated and described herein, as they are merely by way of some examples thereof, but rather, should be fully commensurate with that of the claims appended hereafter and their functional equivalents.

1. A method of wireless communication performed by a first user equipment (UE), the method comprising:
transmitting, to a second UE, first stage sidelink control information (SCI-1) using a first set of resources of a resource pool (RP), wherein the RP indicates resources reserved for communicating the SCI-1; and
transmitting, to the second UE, the SCI-1 using a second set of resources of the RP, wherein the second set of resources is different from the first set of resources.

2. The method of claim 1, further comprising:
receiving, from a base station (BS), an RP configuration that indicates the RP.

3. The method of claim 1, further comprising:
receiving, from a third UE, an RP configuration that indicates the RP.

4. The method of claim 1, further comprising:
transmitting, to the second UE, a configuration that indicates a location of at least one of the first set of resources or the second set of resources.

5. The method of claim 4, wherein the configuration is based on a distance between the first UE and the second UE.

6. The method of claim 1, wherein at least one of the first set of resources or the second set of resources is based on an identifier associated with the first UE.

7. The method of claim 1, wherein the SCI-1 indicates resources reserved for communicating one or more transport blocks.

8. The method of claim 1, further comprising:
transmitting the SCI-1 in a first slot; and
transmitting the SCI-1 in a second slot, wherein the first slot is different from the second slot.

9. The method of claim 8, further comprising transmitting a transport block (TB) in the first slot, wherein a resource reservation associated with the first TB is based on a packet delay budget associated with the first TB.

10. The method of claim 1, wherein the SCI-1 comprises at least one of:
a time domain resource allocation (TDRA) or a frequency domain resource allocation (FDRA) associated with a transport block (TB).

11. The method of claim 1, wherein the SCI-1 indicates that physical sidelink shared channel (PSSCH) decoding is not required.

12. The method of claim 1, further comprising:
mapping the first set of resources to a first slot and a first frequency range; and
mapping the second set of resources to a second slot and a second frequency range, wherein:
the second slot is different from the first slot; and
the second frequency range is different from the first frequency range.

13. The method of claim 1, further comprising:
mapping the first set of resources to a sub-slot of a plurality of sub-slots of a first slot; and
mapping the second set of resources to a sub-slot of a plurality of sub-slots of a second slot, wherein the second slot is different from the first slot.

14. The method of claim 1, further comprising:
selecting at least one of a time domain index or a frequency domain index associated with the first set of resources based on at least one of:
a slot identifier associated with the first set of resources;
a sub-slot identifier associated with the first set of resources;
an identifier associated with the first UE;
an identifier associated with the second UE; or
an identifier associated with the combination of the first UE and the second UE.

15. The method of claim 1, further comprising:
selecting at least one of a candidate set of time domain indexes or a candidate set of frequency domain indexes associated with the first set of resources based on at least one of:
a slot identifier associated with the first set of resources;
a sub-slot identifier associated with the first set of resources;
an identifier associated with the first UE;
an identifier associated with the second UE;
a total number of time domain resources in the RP; or
a total number of frequency resources in the RP; and
selecting the first set of resources based on at least one of the candidate set of time domain indexes or the candidate set of frequency domain indexes.

16. A method of wireless communication performed by a first user equipment (UE), the method comprising:
receiving, from a second UE, first stage sidelink control information (SCI-1) using a first set of resources of a resource pool (RP), wherein the RP indicates resources reserved for communicating the SCI-1; and
receiving, from the second UE, the SCI-1 using a second set of resources of the RP, wherein the second set of resources is different from the first set of resources.

17. The method of claim 16, wherein the receiving the SCI-1 using the first set of resources and the second set of resources is based on a distance between the first UE and the second UE.

18. The method of claim 16, further comprising:
receiving, from the second UE, second stage sidelink control information (SCI-2); and
decoding, from the SCI-2, an identifier associated with the second UE, wherein:
the receiving the SCI-1 using the first set of resources and the second set of resources is based on the identifier associated with the second UE.

19. The method of claim 16, further comprising:
receiving, from the second UE, second stage sidelink control information (SCI-2); and
decoding, from the SCI-2, an indicator that indicates whether the UE should receive the SCI-1, wherein:
the receiving the SCI-1 using the first set of resources and the second set of resources is based on the indicator.

20. The method of claim 19, wherein the indicator is based on a packet delay budget associated with a transport block transmitted by the second UE.

21. A first user equipment (UE) comprising a transceiver, a memory, and a processor coupled to the transceiver and the memory, the first UE configured to:
transmit, to a second UE, first stage sidelink control information (SCI-1) using a first set of resources of a resource pool (RP), wherein the RP indicates resources reserved for communicating the SCI-1; and
transmit, to the second UE, the SCI-1 using a second set of resources of the RP, wherein the second set of resources is different from the first set of resources.

22. The first UE of claim 21, wherein the first UE is further configured to:
receive an RP configuration that indicates the RP from at least one of:
a base station (BS); or
a third UE.

23. The first UE of claim 21, wherein the first UE is further configured to:
transmit, to the second UE, a configuration that indicates a location of at least one of the first set of resources or the second set of resources.

24. The first UE of claim 21, wherein at least one of the first set of resources or the second set of resources is based on an identifier associated with the first UE.

25. The first UE of claim 21, wherein the first UE is further configured to:
transmit the SCI-1 in a first slot;
transmit the SCI-1 in a second slot, wherein the first slot is different from the second slot.

26. The first UE of claim 25, wherein:
the first UE is further configured to transmit a transport block (TB) in the first slot; and
a resource reservation associated with the first TB is based on a packet delay budget associated with the first TB.

27. The first UE of claim 21, wherein the SCI-1 indicates that physical sidelink shared channel (PSSCH) decoding is not required.

28. A first user equipment (UE) comprising a transceiver, a memory, and a processor coupled to the transceiver and the memory, the first UE configured to:
receive, from a second UE, first stage sidelink control information (SCI-1) using a first set of resources of a resource pool (RP), wherein the RP indicates resources reserved for communicating the SCI-1; and
receive, from the second UE, the SCI-1 using a second set of resources of the RP, wherein the second set of resources is different from the first set of resources.

29. The first UE of claim 28, wherein the receiving the SCI-1 using the first set of resources and the second set of resources is based on a distance between the first UE and the second UE.

30. The first UE of claim 28, wherein the first UE is further configured to:
receive, from the second UE, second stage sidelink control information (SCI-2); and
decode, from the SCI-2, an identifier associated with the second UE, wherein:
the receiving the SCI-1 using the first set of resources and the second set of resources is based on the identifier associated with the second UE.
